(19) United States
(12) Patent Application Publication
(10) Pub. No.: US 2016/0284029 A1
(43) Pub. Date: Sep. 29, 2016

(54) Method, System, and Apparatus to Couple Physical and Financial Risks and Risk Measures to Mitigate Risk of Catastrophic Damage to Physical Locations

(71) Applicant: 1234 10th Street LLC, Sammarmish, WA (US)

(72) Inventors: James S. Rhodes, La Jolla, CA (US); Shalini Vajjhala, La Jolla, CA (US)

(21) Appl. No.: 15/078,744

(22) Filed: Mar. 23, 2016

Related U.S. Application Data
(60) Provisional application No. 62/136,965, filed on Mar. 23, 2015.

(51) Int. Cl. G06Q 40/08

(52) U.S. Cl. CPC G06Q 40/08

(57) ABSTRACT

Described are methods and systems, including computer program products, for securitizing catastrophic risk. A computing device receives financial instrument data including a premium amount and a coupon amount, where the financial instrument reflects a financial risk that corresponds to one or more physical risks. The computing device determines a first expected loss associated with the financial risk reflected in the financial instrument, and determines a second expected loss associated with the financial risk reflected in the financial instrument where the financial risk is adjusted to compensate for risk-reducing measures and/or risk-contributing measures. The computing device determines a differential between the first and second expected losses. The computing device calculates a credit to parties responsible for the risk-reducing measures and calculates a debit to parties responsible for the risk-contributing measures based upon the differential. The computing device adjusts the premium and/or the coupon based upon the credit and/or the debit.

### RELATED APPLICATIONS

This application claims priority to U.S. Provisional Patent Application No. 62/136,965, filed on Mar. 23, 2015, the entirety of which is incorporated herein by reference.

### TECHNICAL FIELD

The subject matter of this application relates to systems, methods, and apparatuses, including computer program products, for (i) effectively characterizing and coupling physical and financial risks, risk exposures, and impacts of risk measures; (ii) enabling securitization and/or re-pricing of risk-related assets, instruments, options, risk measures and related activities, initiatives, entities, and/or decisions and (iii) designing, constructing, and implementing physical measures and infrastructure that optimize social and economic benefits of associated risk reductions.

### BACKGROUND

Risks—including, for example, physical risks related to natural hazards, human risks related to terrorism, warfare, casualty or liability events, engineering risks related to infrastructure failures, risks related to health and mortality, as well as financial risks in their various forms—are often impacted by various types of risk factors. Risk factors, in turn, may be impacted by various types of decisions, projects, initiatives, activities taken by individuals, organizations, groups, communities, and various other types of actors, collectively referred to herein as measures. Measures may impact risk factors in ways that reduce, contribute to, and/or increase risk, risk exposure, losses, damages, probabilities of losses or damages, expected losses and damages, and market valuations of related entities, assets, instruments, options revenue streams, and/or programs. The impacts of measures may be direct or indirect. Examples of direct risk measures related to flood risk, for example, may include seawalls and other physical infrastructure employed to directly insulate assets from flooding events or otherwise directly mitigate flood risk. Examples of indirect risk measures also related to flood risk, for example, may include building codes and property insurance programs that effectively impact the extent and/or quality of construction in areas with high flood risk, and emissions-generating activities that may contribute to increased atmospheric temperatures and sea-surface temperatures, thereby increasing the frequency and severity of storms capable of causing flood events.

Financial risks are often associated with physical risks, such as those related to the flooding examples noted above, as well as those related to other types of natural risks, human risks, and/or engineering risks, for example. Examples of such financial risks may include those associated with indemnified losses on insurance policies covering property, life and health, and business interruption. They may also include financial risks associated with business interruption, revenue disruption, compliance with service reliability obligations, financial losses from property damage, health costs, and/or increased mortality, for example. They may further include knock-on financial risks associated with debt default, bankruptcies, correlated defaults and/or foreclosures, reduced tax receipts, and broader systemic risks that may propagate through financial systems via contracts, counterparties, and/or via perceptions of contagion, for example.

Despite the inherent relations between physical risks, financial risks, and economic risks, and despite the use of various instruments, programs, and strategies to manage financial risks related to physical risks, the ability for risks to be impacted by human and/or organizational decisions, activities, and/or initiatives is rarely leveraged in financial risk management strategies. Where this ability is recognized at all, the relations are often poorly characterized and viewed primarily as risk factors and/or as issues to be incorporated in future financial risk management strategies. For example, potential flood mitigation measures (e.g., construction of seawalls, food barriers, and drainage enhancement infrastructure or the rehabilitation of reefs, beaches, and/or mangrove forests) may be recognized in terms such as: if implemented, such measures could, in principal, reduce flood risks, expected damages, and insurance premiums. The impacts on financial risks of measures affecting physical risks are generally not quantified in a way that enables their integration into financial instruments, financial transactions, pricing or re-pricing of assets, instruments, options, programs, initiatives, decisions, etc. in a manner that provides feedback-mechanism supporting the implementation and/or maintenance of measures to reduce physical risks.

Further, the impacts on financial and economic risks of measures affecting physical risks are generally not quantified in a way that enables their integration into the design, construction, and broader implementation of these measures. To the extent that risk impacts are integrated into design, construction, and implementation, it is generally through generic standards-based approaches, which do not reflect expected economic or financial impacts. As a result, enormous capital expenditures can be invested in long-lived infrastructure that fails to deliver key financial and economic benefits. Similarly, opportunities are missed to prevent substantial economic and financial losses because it is not clear how effective risk reduction measures can be designed, engineered, and constructed to optimize prevent these losses and deliver financial and economic benefits.

### SUMMARY

Therefore, what is needed are systems and methods that provide the ability to (i) appropriately characterize and quantify impacts of measures affecting physical risks, (ii) to integrate these impacts into financial instruments, transactions, and the like, and (iii) to design, engineer, construct, and implement risk reduction measures that optimize and deliver financial and economic benefits achievable through physical risk reduction measures, as disclosed herein. Such systems and methods can provide a number of important benefits, including: (i) valuation, pricing and re-pricing of related financial instruments, assets, programs, initiatives, revenue streams, options, etc.; (ii) securitization of the risk impacts and/or measures that impact physical risks; (iii) creation of rational, risk-based financial incentives related to risk-impacting measures; (iv) production and issuance of new financial instruments, financial products, and financial programs that provide for such securitization and/or incentive creation; and (v) identification of infrastructure projects and measures that are capable of delivering key financial and economic benefits of physical risk reductions; (vi) design, engineering, construction, and implementation of infrastructure projects and measures that realize key financial and economic benefits of physical risk reductions; and (vii) development of new data products that enable both informed decision making and realization of the above benefits.

The invention, in one aspect, features a method for securitizing catastrophic risk. A computing device receives financial instrument data including a premium amount paid by sponsors of the financial instrument to an issuer of the financial instrument and a coupon amount paid by the issuer to an investor in the financial instrument, where the financial instrument reflects a financial risk that corresponds to one or more physical risks. The computing device determines a first expected loss associated with the financial risk reflected in the financial instrument. The computing device determines a second expected loss associated with the financial risk reflected in the financial instrument, where the financial risk is adjusted to compensate for risk-reducing measures and/or risk-contributing measures. The computing device determines a differential between the first expected loss and the second expected loss. The computing device calculates a credit to one or more parties responsible for the risk-reducing measures based upon the differential. The computing device calculates a debit to one or more parties responsible for the risk-contributing measures based upon the differential. The computing device adjusts the premium amount and/or the coupon amount based upon the credit and/or the debit.

The invention, in another aspect, features a system for securitizing catastrophic risk. The system includes a computing device configured to receive financial instrument data including a premium amount paid by sponsors of the financial instrument to an issuer of the financial instrument and a coupon amount paid by the issuer to an investor in the financial instrument, where the financial instrument reflects a financial risk that corresponds to one or more physical risks. The computing device is configured to determine a first expected loss associated with the financial risk reflected in the financial instrument. The computing device is configured to determine a second expected loss associated with the financial risk reflected in the financial instrument, where the financial risk is adjusted to compensate for risk-reducing measures and/or risk-contributing measures. The computing device is configured to determine a differential between the first expected loss and the second expected loss. The computing device is configured to calculate a credit to one or more parties responsible for the risk-reducing measures based upon the differential. The computing device is configured to calculate a debit to one or more parties responsible for the risk-contributing measures based upon the differential. The computing device is configured to adjust the premium amount and/or the coupon amount based upon the credit and/or the debit.

The invention, in another aspect, features a computer program product for securitizing catastrophic risk. The computer program product includes instructions operable to cause a computing device to receive financial instrument data including a premium amount paid by sponsors of the financial instrument to an issuer of the financial instrument and a coupon amount paid by the issuer to an investor in the financial instrument, where the financial instrument reflects a financial risk that corresponds to one or more physical risks. The computer program product includes instructions operable to cause the computing device to determine a first expected loss associated with the financial risk reflected in the financial instrument. The computer program product includes instructions operable to cause the computing device to determine a second expected loss associated with the financial risk reflected in the financial instrument, where the financial risk is adjusted to compensate for risk-reducing measures and/or risk-contributing measures. The computer program product includes instructions operable to cause the computing device to determine a differential between the first expected loss and the second expected loss. The computer program product includes instructions operable to cause the computing device to calculate a credit to one or more parties responsible for the risk-reducing measures based upon the differential. The computer program product includes instructions operable to cause the computing device to calculate a debit to one or more parties responsible for the risk-contributing measures based upon the differential. The computing device is configured to adjust the premium amount and/or the coupon amount based upon the credit and/or the debit.

The invention, in another aspect, features a system and method for designing, engineering, constructing, and/or otherwise implementing risk reduction measures, including infrastructure and related physical risk reduction measures. The system includes a computing device that receives information about multiple options—including design options, engineering options, construction options, and/or other implementation options—to implement the risk reduction measures, where such implementation options may provide different levels of protection, and where one implementation option may include implementation of no risk measures, the “no-implementation” option. The computing device is configured to receive both technical information regarding and financial information, such as cost information, for each implementation option. The computing devise is configured to calculate expected losses associated with each implementation option and to calculate the benefits of each implementation option from differences in the expected loss values. The computing devise is configured to generate outputs that characterize the total, net, and marginal benefits associated with each implementation option and to identify the optimal implementation options according to these values.

The invention, in a related aspect, is further configured to receive financial instrument data including a premium amount paid by sponsors of the financial instrument to an issuer of the financial instrument and a coupon amount paid by the issuer to an investor in the financial instrument, where the financial instrument reflects a financial risk that corresponds to one or more physical risks. The computing device is configured to determine multiple expected loss values associated with the financial risk reflected in the financial instrument, where the financial risk is adjusted to compensate for each implementation option of the risk-reducing measures and/or risk-contributing measures. The computing device is configured to determine differentials between the multiple expected loss values and to calculate credits to one or more parties responsible for the risk-reducing measures based upon the differentials. The computing device is configured to calculate debits to one or more parties responsible for the risk-contributing measures based upon the differentials. The computing device is configured to adjust the premium amounts and/or the coupon amounts based upon the credits and/or the debits for each party and implementation option. The computing device is configured to factor these option-specific credits, deficits and adjusted premium values into computations characterizing the total, net, and marginal benefits associated with each implementation option and to identify the optimal implementation options according to these values.

The invention, in another aspect, features a method for implementing physical risk reduction measures for catastrophic risk. A server computing device receives information for a plurality of physical infrastructure implementation options relating to risk reduction measures, where each physical infrastructure implementation option provides a different level of risk reduction. The server computing device receives technical information relating to design and construction of each physical infrastructure implementation option. The server computing device receives financial information relating to each physical infrastructure implementation option. The server computing device determines an expected loss value for each physical infrastructure implementation option and determines a benefit for each physical infrastructure implementation option based upon differences in the expected loss values for the physical infrastructure implementation options. The server computing device generates a matrix of values that characterize total, net, and marginal benefits associated with each physical infrastructure implementation option. The server computing device identifies an optimal physical infrastructure implementation option based upon the matrix of values, and generates an engineering plan to design and construct the optimal physical infrastructure implementation option at a physical location.

The invention, in another aspect, features a system for implementing physical risk reduction measures for catastrophic risk. The system comprises a server computing device configured to receive information for a plurality of physical infrastructure implementation options relating to risk reduction measures, where each physical infrastructure implementation option provides a different level of risk reduction. The server computing device receives technical information relating to design and construction of each physical infrastructure implementation option. The server computing device receives financial information relating to each physical infrastructure implementation option. The server computing device determines an expected loss value for each physical infrastructure implementation option and determines a benefit for each physical infrastructure implementation option based upon differences in the expected loss values for the physical infrastructure implementation options. The server computing device generates a matrix of values that characterize total, net, and marginal benefits associated with each physical infrastructure implementation option. The server computing device identifies an optimal physical infrastructure implementation option based upon the matrix of values, and generates an engineering plan to design and construct the optimal physical infrastructure implementation option at a physical location.

The invention, in another aspect, features a computer program product, tangibly embodied in a non-transitory computer readable storage device, for implementing physical risk reduction measures for catastrophic risk. The computer program product includes instructions operable to cause the server computing device to receive information for a plurality of physical infrastructure implementation options relating to risk reduction measures, where each physical infrastructure implementation option provides a different level of risk reduction. The server computing device receives technical information relating to design and construction of each physical infrastructure implementation option. The server computing device receives financial information relating to each physical infrastructure implementation option. The server computing device determines an expected loss value for each physical infrastructure implementation option and determines a benefit for each physical infrastructure implementation option based upon differences in the expected loss values for the physical infrastructure implementation options. The server computing device generates a matrix of values that characterize total, net, and marginal benefits associated with each physical infrastructure implementation option. The server computing device identifies an optimal physical infrastructure implementation option based upon the matrix of values, and generates an engineering plan to design and construct the optimal physical infrastructure implementation option at a physical location.

Any of the above aspects can include one or more of the following features. In some embodiments, the one or more physical risks correspond to a potential for catastrophic damage at a physical location. In some embodiments, the risk-reducing measures include direct measures and indirect measures that mitigate and/or eliminate the potential for catastrophic damage at the physical location. In some embodiments, the risk-reducing measures include direct measures and indirect measures that enhance and/or fail to mitigate the potential for catastrophic damage at the physical location.

In some embodiments, the server computing device receives financial instrument data including a premium amount paid by sponsors of the financial instrument to an issuer of the financial instrument and a coupon amount paid by the issuer to an investor in the financial instrument, where the financial instrument reflects a financial risk that corresponds to one or more physical risks associated with the plurality of physical infrastructure implementation options. The server computing device determines a first expected loss associated with the financial risk reflected in the financial instrument and determines a second expected loss associated with the financial risk reflected in the financial instrument, where the financial risk is adjusted to compensate for risk-reducing measures and/or risk-contributing measures. The server computing device determines a differential between the first expected loss and the second expected loss. The server computing device determines a credit to one or more parties responsible for the risk-reducing measures based upon the differential and determines a debit to one or more parties responsible for the risk-contributing measures based upon the differential. The server computing device adjusts the premium amount and/or the coupon amount based upon the credit and/or the debit, and adjusts the matrix of values that characterize total, net, and marginal benefits associated with each physical infrastructure implementation option based upon the adjusted premium amount and/or the adjusted coupon amount.

In some embodiments, the plurality of physical infrastructure implementation options correspond to design and construction of physical infrastructure changes that reduce a risk of catastrophic damage to a physical location. In some embodiments, the plurality of physical infrastructure implementation options includes an option to not implement any physical infrastructure changes. In some embodiments, the risk reduction measures include direct risk reduction measures and indirect risk reduction measures. In some embodiments, the direct risk reduction measures include construction of physical infrastructure to insulate a physical location from a risk of catastrophic damage. In some embodiments, the indirect risk reduction measures include revising building codes and property insurance programs to affect quality of physical infrastructure design and construction in a physical location that is susceptible to a risk of catastrophic damage.

Other aspects and advantages of the invention described herein will become apparent from the following detailed description, taken in conjunction with the accompanying drawings, illustrating the principles of the invention by way of example only.

### BRIEF DESCRIPTION OF THE DRAWINGS

The advantages of the invention as described above, together with further advantages, may be better understood by referring to the following description taken in conjunction with the accompanying drawings. The drawings are not necessarily to scale, emphasis instead generally being placed upon illustrating the principles of the invention.

FIG. 1 illustrates an example implementation of a risk model framework.

FIG. 2 illustrates an example implementation of the risk model with a multi-period mechanism, which is useful for pricing assets, instruments, measures, and options.

FIG. 3 illustrates an example structure for conventional catastrophe bonds used to securitize catastrophic risk, which provides a basis for certain novel financial instruments enabled by the risk model framework.

FIG. 4 illustrates an example of the relation between conventional Cat-Bond structures and risk-impacting Measures.

FIG. 5 is a block diagram of a system for modeling risk and risk-impacting measures for securitizing catastrophic risk.

FIG. 6 illustrates an example structure for financial instruments, based in part on the structure of conventional Cat-Bond instruments, to provide financial feedback mechanisms to parties potentially responsible for Risk-impacting Measures and to enable participation by Risk-interested Parties.

FIG. 7 provides a simplified illustration of Premiums and Premium Differentials for a series of four issuances of financial instruments.

FIG. 8 illustrates an example process flow to design, characterize, and evaluate risk impacts from Measures and Factor-contingent Financial Instruments.

FIG. 9 illustrates a process flow to structure, issue, re-issue, and/or service recurringly issuable Factor-contingent Financial Instruments.

FIG. 10 illustrates components of a system to determine economic and/or financial credits in certain embodiments.

FIG. 11 illustrates an example graphic characterizing the benefits, costs, financial credits, and costs less financial credits for multiple implementation options of a risk-reducing measure.

### DETAILED DESCRIPTION

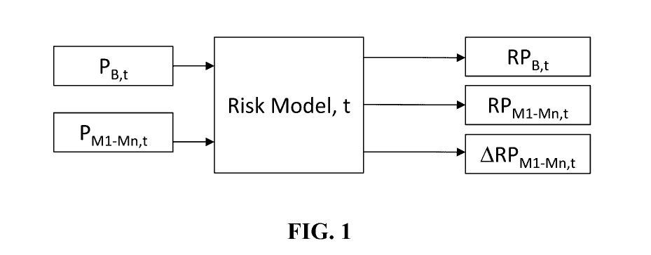

FIG. 1 illustrates an example implementation of a risk model framework. The example framework includes model inputs of: (i) Parameter sets used to specify one or more baseline scenarios for time period “t” (“P_{B, t}”); and Parameter sets used to specify one or more scenarios with risk-impacting Measures 1-n for time period “t” (“P_{M1-Mn, t}”), which can include scenarios representing implementation of Measures individually or in various combinations. The example framework includes model outputs of: (i) one or more Baseline Risk Profiles for time period “t” (“RP_{B, t}”); (ii) one or more Risk Profiles for scenarios with Measures 1-n in time period “t” (“RP_{B, t}”), which may include scenarios representing implementation of Measures individually or in various combinations; and (iii) Risk Profile Differentials for time period t, characterizing changes from the one or more baseline Risk Profiles resulting from the Measures in time period “t” (“ΔRP_{M1-Mn, t}”).

The Parameter sets P_{B,t} and P_{M1-Mn, t}, and/or other inputs to the risk model may include data and/or information on exposures to the risks being evaluated, including but not limited to geocoding data and other information specific to the geographical area of interest, as well as data and information regarding physical characteristics of the exposure. In some cases, inputs to the risk model framework may also include information on the financial terms of related financial instruments, including but not limited to terms for insurance contracts, catastrophe bond instruments, as discussed below, Factor-contingent Financial Instruments, as discussed below, mortgage instruments, revenue bonds, general obligation bonds, and/or other types of financial agreements with counterparty exposure to the physical risk. Similarly, risk profile outputs of the risk model framework can comprise characterizations of financial risk profiles associated with such financial instruments.

Note that the volumes of data considered within such risk models, the complexity of computations employed by such risk models, and/or the number of iterative calculations run in operating such risk models—and/or otherwise required to effectively characterize such risk profiles and risk profile differentials—generally causes it to be impractical, if not impossible, for such risk models—and therefore associated methods, systems, and apparatuses employing or otherwise relying on such risk models—to be implemented independently from a machine and/or computing environment. Also note that such risk models embody a variety of advanced modeling tools, techniques, methods, systems, and apparatuses, including but not limited to those associated with statistical methods, simulation tools, Monte Carlo style analyses, and the like. Technical aspects of such modeling tools are therefore disclosed here only with sufficient detail to characterize their integration and application within the methods, systems, and apparatuses that comprise the primary subjects of the current disclosure.

The Baseline Risk Profiles output from the risk model illustrated in FIG. 1 may be useful for pricing and/or re-pricing assets, financial instruments, programs, and/or revenue streams, for example. The Risk Profiles for scenarios with Measures output from the risk model illustrated in FIG. 1 are useful for establishing design standards for risk Measures, for example. The combination of the Risk Profiles for scenarios with Measures and information regarding Measure Implementation (not explicitly represented in FIG. 1) are useful for establishing one or more re-calibrated Baseline Risk Profiles and/or Parameters for re-calibrated Baseline Risk Profiles for future time periods, for example (e.g., RP_{B, t+1}, and P_{B, t+1}, respectively), which are useful in pricing and re-pricing of Real Options, for example. The Risk Profile Differentials output from the risk model illustrated in FIG. 1 (on their own or in combination with the other various Risk Profile outputs) are useful for a variety of purposes including but not limited to: (i) developing, designing, defining, and/or issuing new financial instruments—such as Factor-contingent Financial Instruments, as discussed below, for example; (ii) developing, designing, defining, and/or implementing new programs to distribute funds intended to advance risk reductions, as discussed below, for example; and/or (iii) for creating design specification for projects intended to implement the specified Measures.

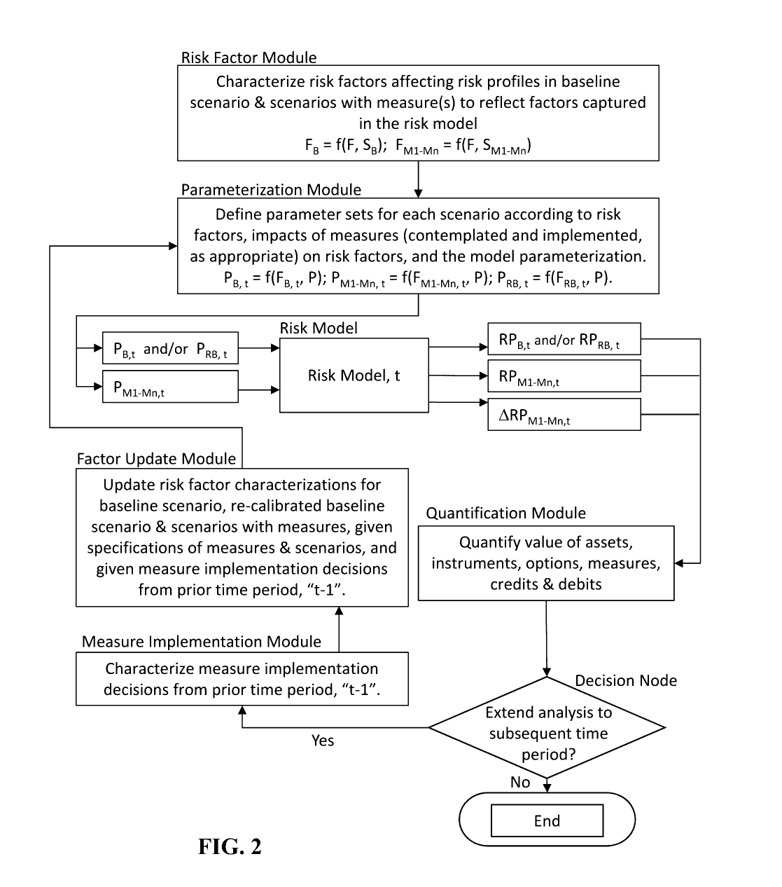

FIG. 2 illustrates an example implementation of a method, system, and/or apparatus for the risk model with a multi-period mechanism, which may be useful for pricing assets, instruments, measures, and options. This example implementation begins with Risk Factor Module that characterizes the Risk Factors affecting Risk Profiles for one or more Baseline scenarios and one or more scenarios with Measures. The Risk Factors for the baseline scenario(s) in time period “t” (“F_{B, t}”) may be defined as a function of the set of all factors represented in the risk model (“F”) and the Specifications for the baseline scenario(s) for period “t” (“S_{B, t}”). The Risk factors for the one or more scenarios with Measures 1-n in period “t” (“F_{M1-Mn, t}”) may be defined as a function of the set of factors represented in the risk model (“F”) and the Specifications for the Measures 1-n and/or the Specifications for the scenarios with Measures 1-n for time period “t” (“S_{M1-Mn, t}”).

In this example, the Risk Factor Module is followed by a Parameterization Module that characterizes the risk model Parameters for the Baseline Scenario(s), the scenarios with Measures 1-n, and the Recalibrated Baseline Scenario, if applicable. Inputs to the Parameterization Module may also include Factor Characterizations from the Risk Factor Module and Updated Risk Factor Characterizations from the Factor Update Module. Parameters for the Baseline Scenario(s) in period “t” (“P_{B, t}”) may be defined as a function of the Risk Factor characterization for the Baseline Scenario(s) for period “t” (“F_{B, t}”) and the risk model parameterization—e.g., the set of parameters used in the risk model (“P”). Parameters for the scenarios with Measures 1-n for period “t” (“P_{M1-Mn, t}”) may be defined as a function of the Risk Factor characterizations for the scenarios with Measures 1-n for period “t” (“F_{M1-Mn, t}”) and the risk model parameterization (“P”). Parameters for the one or more Recalibrated Baseline Scenarios in period “t” (“P_{RB, t}”), if applicable, may be defined as a function of the Risk Factor characterizations for the Recalibrated Baseline Scenario(s) in time period “t” (“F_{RB, t}”)—which may reflect measure implementation decisions from the prior period, “t-1”, among other things—and the risk model parameterization (“P”).

In this example, the parameter sets for each of the Baseline Scenario(s) in time period “t” (“P_{B, t}”), the Recalibrated Baseline Scenario(s) (“P_{RB, t}”), if applicable, and the scenarios with Measures 1-n (“P_{M1-Mn, t}”) represent key inputs to characterize scenario-specific risk profiles for the Baseline Scenario (“R_{PB, t}”), the Recalibrated Baseline Scenario (“R_{PRB, t}”), the scenarios with Measures 1-n (“R_{PM1-Mn}”), and risk profile differentials for the various scenarios (“ΔR_{PM1-Mn}”) in the Risk Model. Additional data and/or information inputs to the Risk Model can also be provided, either within the scenario-specific parameter sets or in addition to those parameter sets, as noted above with reference to FIG. 1.

It should be appreciated that the Risk Model computes Risk Profiles and Differentials using any combination of a variety of computerized methods, tools, techniques, processes, and additional data inputs and variables. As noted above, the volumes of data considered within such risk models, the complexity of computations employed by such risk models, and/or the number of iterative calculations run in operating such risk models—and/or otherwise required to effectively characterize such risk profiles and risk profile differentials—generally causes it to be impractical if not impossible for such risk models—and therefore associated methods, systems, and apparatuses employing or otherwise relying on such risk models—to be implemented independently from a machine and/or computing environment.

In the example illustrated in FIG. 2, the Risk Profiles and Risk Profile Differentials generated in the Risk Model represent key inputs to a Quantification Module. The Quantification Module uses the Risk Profiles and Risk Profile Differentials, along with any combination of a variety of other inputs, data, and information regarding assets, instruments, options, agreements, and/or measures, including aspects related to potential credits, debits, values, and/or cash flow streams that may be relevant, available, and/or convenient, to quantify the values of relevant assets, instruments, options, measures, credits, debits, and/or cash flow streams in light of the scenario-specific Risk Profiles and Risk Profile Differentials. An example of how this quantification may be defined in the context of potential Factor-contingent Financial Instruments is provided below. The values generated in the Quantification Module are useful for: valuing, pricing and/or re-pricing various assets, instruments, options and/or Measures; defining values relevant to various assets, instruments, options, and/or Measures; specifying payments within novel financial instruments and/or programs; and/or informing decisions regarding various assets, instruments, options, and/or Measures. In some embodiments, the functions of the Quantification Module are integrated with the Risk Model.

In the example illustrated in FIG. 2, the Quantification Module is followed by a decision node. The Decision Node represents a determination to extend the analysis to a subsequent time period. If the result of this Decision Node is determined to be “No”, then the process is terminated and results generated throughout the process may be aggregated and/or otherwise processed in a variety of ways. If the result of this Decision Node is determined to be “Yes”, then the result can be to proceed to the Measure Implementation Module.

In this example, the Measure Implementation Module is used to enable changes to the conditions, states of factors, and/or scenario parameters used in the analysis across consecutive time periods. Toward this end, the Measure Implementation Model enables Measure Implementation Decisions from the previous time period “t−1”, which may follow from the outputs of the Quantification Module for that period, to be effectively characterized. For example, in characterizing the value of Real Options, decisions regarding Measure Implementation can be defined as a function of relative values associated with the various Measures evaluated for different timer periods in the scenarios. For example, a Measure or combination of Measures can be assumed to be implemented in a particular time period if the value defined for the discounted cash flows associated with the Measure implementation in a particular time period is positive; alternatively, the Measures or combination of Measures associated with the greatest value for the discounted cash flows can be assumed to be implemented. Alternatively, Measure Implementation Decisions can be determined in advance for each scenario to ensure adequate sampling of the decision space, for example. Such Measure Implementation Functions inherently reflect the specific purpose of the analysis and/or the Real Options under consideration. Note that various types of Measure Implementation Decisions, beyond those discussed in the examples here, can also be characterized with the Measure Implementation Module.

In the example illustrated in FIG. 2, results from the Measure Implementation Module are passed to the Factor Update Module. The Factor Update Module generates updated Risk Factor Characterizations for scenarios in the now-current time period “t”. These Risk Factor Characterizations may include factors for the one or more Baseline Scenarios (“F_{B, t}”), the one or more Recalibrated Baseline Scenarios (“F_{RB, t}”) and for the one or more scenarios with Measures (“F_{M1-Mn, t}”). The Risk Factor Characterizations are defined according to Specifications for the scenarios with Measures (“S_{M1-Mn, t}”) and the Recalibrated Baseline Scenario (“S_{RB, t}”). The Specifications for the Recalibrated Baseline Scenario reflects the Measure Implementation Decisions from the prior time period (“t−1”), as specified in the Measure Implementation Module.

In the example illustrated in FIG. 2, Factor Characterizations from the Factor Update Module are used as inputs to the Parameterization Module. The process can proceed through the sequence of the Parameterization Module, Risk Model, Quantification Module, Decision Node, Measure Implementation Module, and Factor Update Module as illustrated in FIG. 2, until the Decision at the Decision Node is determined to be “No”, at which point the process is terminated. Results generated throughout the process can be integrated and/or aggregated into various other processes and/or data or information products, which can also reflect data and/or information collected from other processes and/or sources.

Examples of products that may be generated using the example implementation illustrated in FIG. 2 include but are not limited to: valuations for assets, instruments, options, measures, programs, revenues streams, and related tangible and intangible articles with financial risks associated with physical risk factors; assessments of expected losses or damages for risk-exposed assets, instruments, options, measures, programs, revenue streams, and related tangible and intangible articles; guidance for defining design standards for proposed risk-impacting measures and/or design specifications for projects intended to implement particular measures; data to support the distribution of funds to advance risk-reducing projects, initiatives, activities, programs, and/or related efforts, as described further below; data to support the collection of funds from risk-contributing projects, initiatives, activities, programs, and/or related efforts; financial instruments that account for the financial impacts of measures that affect physical risks.

It will be understood by those experienced in the arts of risk modeling, risk quantification, option pricing, and/or pricing of other assets or instruments that the process modules illustrated in FIG. 2 can be integrated, aggregated, disaggregated, and/or embodied in other processes in various ways, as is convenient and/or practical, to achieve the intended function. The example provided in FIG. 2 is structured as illustrated for clarity of disclosure and represents one embodiment for implementing the techniques described herein.

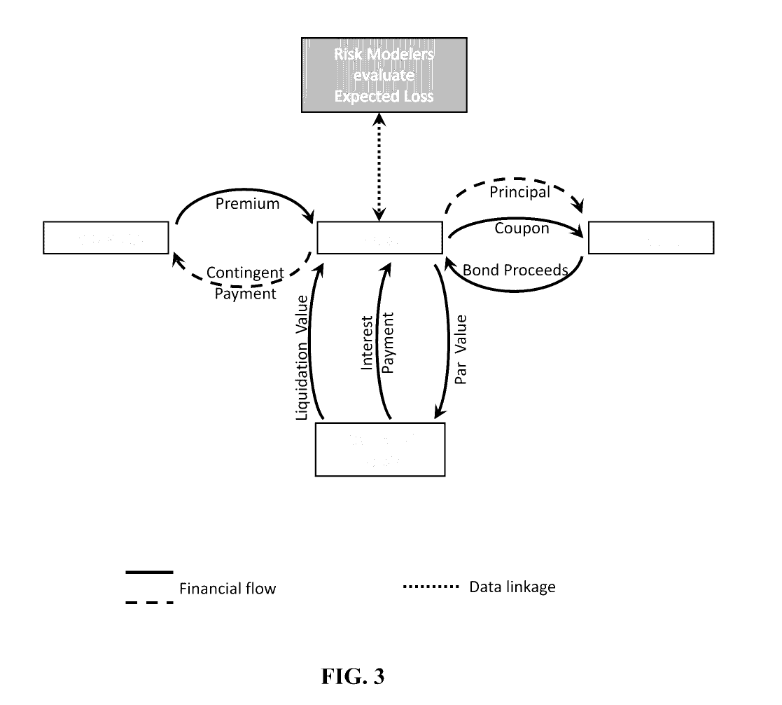

FIG. 3 illustrates an example structure for conventional catastrophe bonds or financial transactions used to securitize catastrophic risk. Numerous types of financial instruments, programs, and strategies currently exist for managing, securitizing, and transferring financial risks, including those associated with physical risk factors. Catastrophe bonds (“Cat-Bonds”) represent one example, which is commonly used to securitize and transfer risks of large losses associated with catastrophic events. Many of the risk classes securitized using Cat-Bonds are considered to result from natural hazards, such as extreme weather events, flooding, and earthquakes; however the Cat-Bond structure illustrated in FIG. 3 can be used to securitize various other types of risk, and this structure is discussed here as an example within a broader class of financial instruments used to securitize, transfer, and/or otherwise manage financial risks that may be associated with physical risks.

Various aspects of the transaction structure illustrated in FIG. 3 are described elsewhere, including U.S. Pat. No. 7,711,634, GAO Report GAO-02-941, and various other publications. The purpose of the discussion here is to provide a foundation for discussing novel aspects of the invention, rather than to provide redundant discussion of aspects elaborated elsewhere.

In the Cat-Bond structure illustrated in FIG. 3, a Cat-Bond issuance, series of Cat-Bond issuances, or program of issuances is issued by an issuer. The issuer can be a large financial institution, a reinsurer, a so-called special purpose entity, or any other designated entity with the capacity to manage the issuance. Cat-bonds are placed with, sold to, and/or distributed to Investors, which pay Proceeds to the Issuer based on an expected return on investment that recognizes the financial risk associated with the bond issuance. Proceeds from the sale of the Cat-Bond equivalent to the bond Par Value are generally placed in a Collateral Account, which often generates a modest amount of interest reflecting the low risk nature of investments qualified for Collateral Account investments. The return on investment to Investors is generally realized through some combination of Coupon payments and the return of the Principal investment equivalent to the bond's Par Value upon the maturity date. The Coupon reflects both the interest earned by the Collateral Account and the Premium paid by the Cat-Bond Sponsor. Repayment of Principal equivalent to the bond Par Value to Investors upon Cat-Bond maturity is contingent on events related to the underlying risk being transferred from the Sponsor to the Investors.

In particular, the payment of Principal from the Collateral Account is generally contingent on the occurrence of a Trigger Event during the risk period of time covered by the Cat-Bond. Trigger Events may be defined in a variety of ways, the most common are defined in terms of: (i) a threshold quantity of indemnified or insured losses attributable to the Sponsor or Sponsor's industry that result from a specific type of event within a specific geographic area during the risk period; (ii) a threshold value realized for a specific value on an index that is related to the underlying risk being transferred; and (iii) a threshold value realized on a specific parameter that is related to the underlying risk being transferred. If the Trigger Event specified in a Cat-Bond issuance occurs during the risk period covered by the issuance, then some or all of the liquidated value of the Collateral Account is transferred to the Sponsor and is no longer available for repayment of Principal to Investors. If the specified Trigger Event does not occur during the specified risk period, then the Principal is repaid to Investors. Note that a number of variants to this structure also exist and/or may be employed (e.g., zero-coupon issuances with variable proceeds, multi-trigger, etc.).

As a result of this structure, the likelihood of a Trigger Event occurring during the specified risk period is a key factor in determining the return on investment that investors demand as compensation for accepting the risk to the Proceeds invested and for accepting exposure to the underlying risk being transferred via the Cat-Bond instrument. Note that the Premium(s) paid by Sponsors reflects the rate of return required by Investors. As a result, the likelihood of a Trigger Event is a key factor in evaluating the financial profile of Cat-Bonds for both Sponsors and Investors.

The likelihood of a Trigger Event occurring during the risk period specified in a Cat-Bond is typically characterized via an independent risk modeling firm, indicated as “Risk Modelers” in FIG. 3. Note that while most of the connections between the entities included in FIG. 3 represent financial flows, the connection from the Risk Modelers to the balance of the entities represents a data linkage. This is because, while financial flows may be exist between Issuers and Risk Modelers, for example, the primary role of Risk Modelers is to provide data characterizing the likelihood of a Trigger Event occurring during the risk period covered by the Cat-Bond issuance in a manner that satisfies both Sponsors and Investors. As such, data is provided to the Risk Modelers regarding the risk classes and other terms of the issuance, and the Risk Modelers return information regarding the financial risk profile of the issuance, for example in terms of the likelihood of a Trigger Event occurring within the risk period of the Cat-Bond.

Note that the volumes of data considered within risk models used by Risk Modelers, the complexity of computations employed by such risk models, and/or the number of iterative calculations run in operating such risk models—and/or otherwise required to effectively characterize the likelihood of a Trigger Event occurring during a risk period—generally causes it to be impractical if not impossible for such risk models—and therefore associated methods, systems, and apparatuses employing or otherwise relying on such risk models—to be implemented independently from a machine and/or computing environment.

While the likelihood of a Trigger Event and the broader financial risk associated with a Cat-Bond may be characterized in a variety of ways, it is often convenient to summarize it in terms of the “Expected Loss” on the investment. This may be equivalent to the probability of a Trigger Event occurring because the expected value of losses to $1.00 of Proceeds invested in a Cat-Bond may be computed as the product of the $1.00 of Principal and the probability of the loss occurring, which may simply be the probability of the Trigger Event. This is relevant to the discussions of quantification, valuation, re-valuation, pricing, and re-pricing appearing throughout this application. Other relevant characterizations of the Trigger Event exist and may be particularly useful for financial instruments having multiple Trigger Events. They include, but are not limited to, the “attachment probability”, or the probability of one or more Trigger Events that will cause at least a portion of the Collateral Account value to be distributed to the Sponsor, and the “exhaustion probability”, or the probability of one or more Trigger Events that will cause the entire value of the Collateral Account to be distributed to the Sponsor. The discussion here focuses on the Expected Loss for simplicity, however, it is also relevant to other characterizations of the financial risk embodied in Cat-Bonds and other related financial instruments.

It may be convenient to discuss the value of financial flows within an instrument structured according to the illustration in FIG. 3, and/or the pricing of such financial instruments, in terms of the Pricing Multiple. The Pricing Multiple can be defined as the Coupon—or rate of return—paid to Investors, or the difference between the Coupon and the Interest earned on the Collateral Account, referred to here as the Coupon Spread, divided by the Expected Loss to which Investors are exposed. For example, if the Expected Loss is 1.5% and the Coupon or Coupon Spread is 6%, then the Pricing Multiple is equal to 4. Similarly, if the Expected Loss is 0.5% and the Coupon or Coupon Spread is 4%, then the Pricing Multiple is equal to 8. In this context, the total value of the Coupon payment, and/or of the Premium required by Sponsors to cover the portion of the total Coupon payment above the interest earned on the Collateral Account, is generally equal or proportional to the product of the Pricing Multiple, the Expected Loss, and the Par Value of the instrument. For example, an instrument with a Par Value of $200 Million, an Expected Loss of 1.5% and a Pricing Multiple of 4 may be equal to $12 Million per year ($200 Million*1.5%*4). The Premium paid by Sponsor(s) of such an instrument is therefore proportional to this $12 Million per year Coupon or Coupon Spread.

The Pricing Multiple is one of a variety of ways that are convenient to quantify the premium required by investors for accepting a given level of risk. The Pricing Multiple can vary with the Expected Loss of financial instruments, with other terms of the instruments (e.g., term or duration), with the perceived quality of the risk modeling, and over time as investors' risk preferences evolve in response to various changes in market conditions and/or perceptions. It is also worth noting that Expected Losses for a single issuance, multiple issuances in a series, and/or for multiple series in a program of issuances can change over time, thereby changing the returns on investment required to compensate investors and changing the premiums required of sponsors over time. This can occur with respect to flooding risks, for example, as ongoing construction increases the value of assets located in risk-exposed locations or as climate changes increase the severity and/or frequency of extreme weather events. As a result, rates of return required by investors and premiums required of sponsors can change over time due to both changes in the underlying risks and due to market conditions affecting the valuation and/or relevant pricing multiples.

The requirement for Risk Modelers to satisfy both Sponsors and Investors, combined with the quantities of funds at stake, generally demands the use of sophisticated computer-implemented risk models, which embody advanced risk modeling tools, techniques, methods, systems, and apparatuses. Technical aspects of these models are therefore disclosed here only with sufficient detail to characterize their integration and application within the methods, systems, and apparatuses that comprise the primary subjects of the current disclosure.

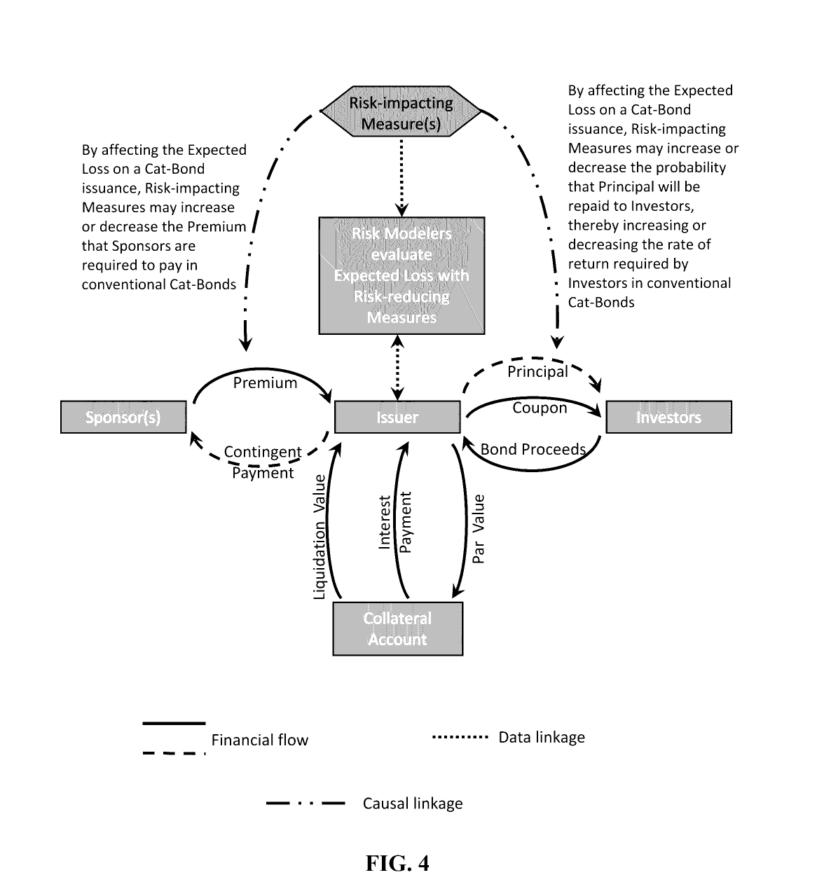

FIG. 4 illustrates an example of the relation between conventional Cat-Bond structures and risk-impacting Measures. It is intended to provide an example of the types of relations that can exist between many types of financial instruments used to securitize risk (as well as many other types of financial instruments, assets, and options, for example) and Measures that impact risk factors underlying the risk to which the instrument(s) are exposed and/or risk that is securitized via the financial instrument. In the context of financial instruments that follow the structure of a typical Cat-Bond, as described in relation to FIG. 3, for example, a Risk-Impacting Measure is broadly defined here as a decision, project, program, activity, initiative, or action taken by one or more people, organizations, institutions, and/or entities that affects the probability of a trigger event occurring during a risk period specified in the financial instrument. In the context of Cat-Bond and related instruments employing certain parametric Trigger Events—including for example quantities or rates of rainfall in a particular time period or sea level measurements on flood gauges, for example, in the context of flood risks—Measures may affect the value of the trigger parameter associated with a particular level of damages or losses from the physical risk, rather than the probability of a particular value for the trigger parameter being achieved. Measures can affect the probability of occurrence, or other components of risk reflected in the financial instrument, by impacting Risk Factors that affect physical risks associated with the financial risks embodied in the Financial Instrument. In this way, Measures can affect the probability of a Trigger Event, the value of a trigger parameter associated with a level of losses, and/or the Expected Loss defined for the financial instrument. They can therefore affect the return on investment required by Investors, as well as the premium required of Sponsors.

Note that, in some cases, Measures contribute to increasing the financial risk and/or Expected Loss or decreasing the Expected Loss on a financial instrument. Measures that reduce the risk and/or Expected Loss can be termed Resiliency Measures and/or Risk-reducing Measures. Measures that increase or otherwise contribute to the risk and/or Expected Loss can be termed Risk-contributing Measures. For example, Resiliency Measures related to flood damages from extreme weather events can directly reduce the probably that assets are exposed to flooding events. Seawalls, dams, berms, and levees are examples of this type. Alternatively, such Measures can reduce the extent of flooding and/or extent of damages to costly assets and infrastructure from flooding events. Enhanced drainage systems, pumping systems, or relocation of sensitive components (such as elevating electrical components above expected high-water marks) are examples of this type. Other types of Resiliency Measures can provide incentives to reduce the installation of costly assets in flood-prone areas and/or provide incentives to relocate costly assets out of flood-prone areas. Zoning rules, building codes, insurance rules, and tax codes are all examples of this type. On the other hand, some types of measures may increase or otherwise contribute to increasing risks, expected damages, and Expected Losses. Inappropriate siting, operations, and/or maintenance programs for wastewater treatment facilities, hazardous material management systems, and/or hazardous material transport systems are examples of this type in the context of the flood risk example. Projects that reduce the effectiveness of flood barriers and/or drainage systems are also examples of this type for the flood risk example. Moreover, activities that increase the frequency and intensity of storms capable of creating severe flooding by, for example, emitting greenhouse gases that contribute toward increasing atmospheric and sea-surface temperatures are also examples of this type with respect to the flood risk example.

As illustrated in FIG. 4, data and/or information regarding Risk-impacting Measures—including both Risk-reducing and Risk-contributing Measures—is collected and/or incorporated in analyses developed by Risk Modelers to characterize the Expected Loss, likelihood of a Trigger Event, losses or damages associated with a Trigger Event, and/or financial risk embodied in a financial instrument. In this example, characterizations of the Expected Loss, likelihood of a Trigger Event, losses or damages associated with a Trigger Event, and/or financial risk that include the impact of Risk-impacting Measures is provided to parties to the financial instrument and be reflected in the return on investment required by Investors, in the Coupon provided to Investors, and/or in the Premium required from the Sponsor of the instrument. Note that the linkages from the Risk-impacting Measures to the Risk Modelers and from the Risk Modelers to the parties to the instrument are primarily data linkages; however, the effect of these data linkages is to create causal linkages from the Risk-impacting Measures to financial flows of the financial instrument, including: (i) the Principal repayment to Investors, by impacting the likelihood that it will be repaid in full; (ii) the rate of return required to compensate Investors for accepting the financial risks reflected in the financial instrument, by impacting the Expected Loss and associated Coupon payment, for example; and (iii) the Premium paid by the Sponsor of the financial instrument.

Importantly, however, financial instruments and financial products, including those that follow the basic structure of conventional Cat-Bonds, generally do not provide any feedback mechanism from the parties to the financial instruments and/or financial products to the Risk-impacting Measures or to parties that may be responsible for implementing the Risk-impacting Measures. Mechanisms that impact the financial risk of the instrument or products are simply treated as factors to be accounted for in the risk modeling for and/or pricing of the financial instrument or products. The methods and systems described herein provide the advantage of characterizing the impacts of potential Risk-impacting Measures in a manner that enables such feedback mechanisms to be provided and/or to create financial incentives—rewards in the form of financial credits, for example, and/or penalties in the form of financial debits, for example—to parties potentially responsible for Risk-impacting Measures. Moreover, the methods and systems described herein leverage the ability to provide such feedback mechanisms and/or financial incentives in order to create incentives related to Risk-impacting Measures, or to collect, distribute, or otherwise manage funds intended to advance objectives related to physical and associated financial risks that may be impacted by such Measures. Each of the following elements are considered to be distinct aspects of the invention disclosed here—methods, systems, and/or apparatuses for: (i) evaluating the financial impacts of Risk-impacting Measures; (ii) for evaluating market valuations for risk-exposed assets, instruments, options, and measures in light of potential Risk-impacting Measures; (iii) for providing new types of data products that characterize the financial impacts and/or consequences for market valuations; (iv) for providing new types of financial instruments and products that leverage such characterizations; (v) for providing new types of financial management to collect and/or distribute funds aimed at advancing risk reductions by increasing Risk-reducing Measures and/or mitigating risk-contributing Measures; and (vi) for providing new financial feedback mechanisms and/or incentives related to Risk-impacting Measures.

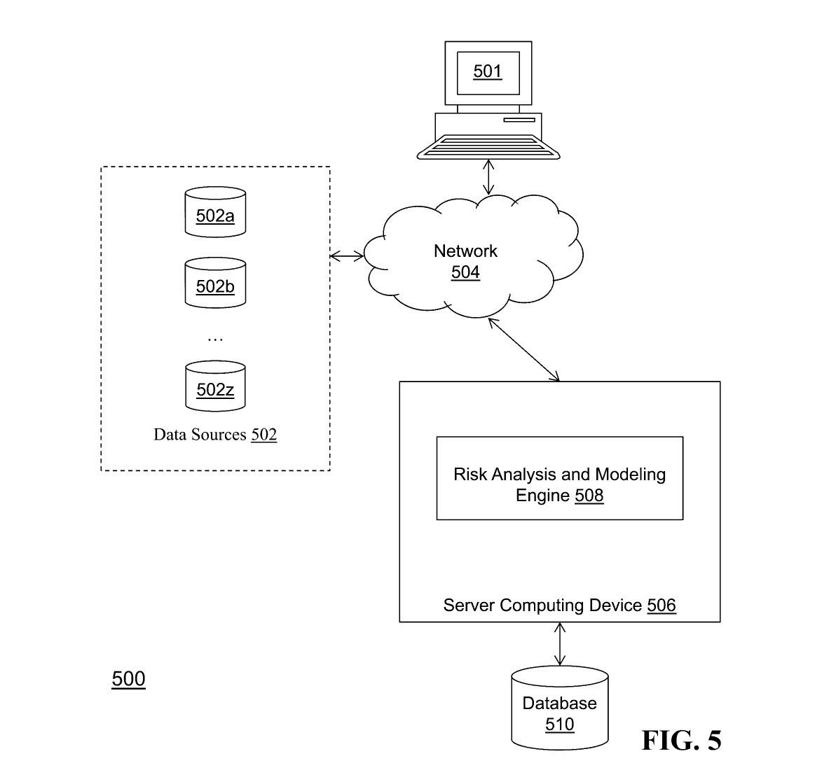

FIG. 5 is a block diagram of a system 500 for modeling risk and risk-impacting measures for securitizing catastrophic risk as described herein. The system 100 includes client device 501, a plurality of data sources 502a-502z (collectively, 502) that contain information utilized to model risk and risk-impacting Measures as described herein, a communications network 504, a server computing device 506 with a risk analysis and modeling engine 508, and a database 510.

The client device 501 connects to the communications network 504 in order to communicate with the other components in the system 500 to provide input and receive output relating to the process of modeling risk and risk-impacting measures for securitizing catastrophic risk as described herein. Exemplary client devices 501 include desktop computers, laptop computers, tablets, mobile devices, smartphones, and internet appliances. It should be appreciated that other types of computing devices that are capable of connecting to the components of the system 500 can be used without departing from the scope of invention. Although FIG. 5 depicts a single device 501, it should be appreciated that the system 500 can include any number of client devices. In some embodiments, the client device 501 also includes a display for receiving data from the other components of the system 500 and displaying the data to a user of the client device 501.

The data sources 502 collect and transmit financial data, risk data, technical data and other types of data to the risk analysis and modeling engine 508 of the server computing device 506.

The communication network 504 enables the other components of the system 500 to communicate with each other in order to perform the process of modeling risk and risk-impacting measures for securitizing catastrophic risk as described herein. The network 504 may be a local network, such as a LAN, or a wide area network, such as the Internet and/or a cellular network. In some embodiments, the network 504 is comprised of several discrete networks and/or sub-networks (e.g., cellular to Internet) that enable the components of the system 100 to communicate with each other.

The risk analysis and modeling engine 508 of the server computing device 506 receives data from the plurality of data sources 502 for modeling risk and risk-impacting measures for securitizing catastrophic risk according to the methods described herein. The risk analysis and modeling engine 508 is a specialized hardware and/or software module executing within the server computing device 506 to perform the risk analysis and modeling process described herein. It should be appreciated that any number of computing devices, arranged in a variety of architectures, resources, and configurations (e.g., cluster computing, virtual computing, cloud computing) can be used without departing from the scope of the invention.

The system 500 also includes a database 510. The database 510 is coupled to the server computing device 506 and stores data used by the risk analysis and modeling engine 508 to perform the risk analysis and modeling process. The database 510 can be integrated with the server computing device 506 or be located on a separate computing device. An example database that can be used with the system 100 is MySQL™ available from Oracle Corp. of Redwood City, Calif.

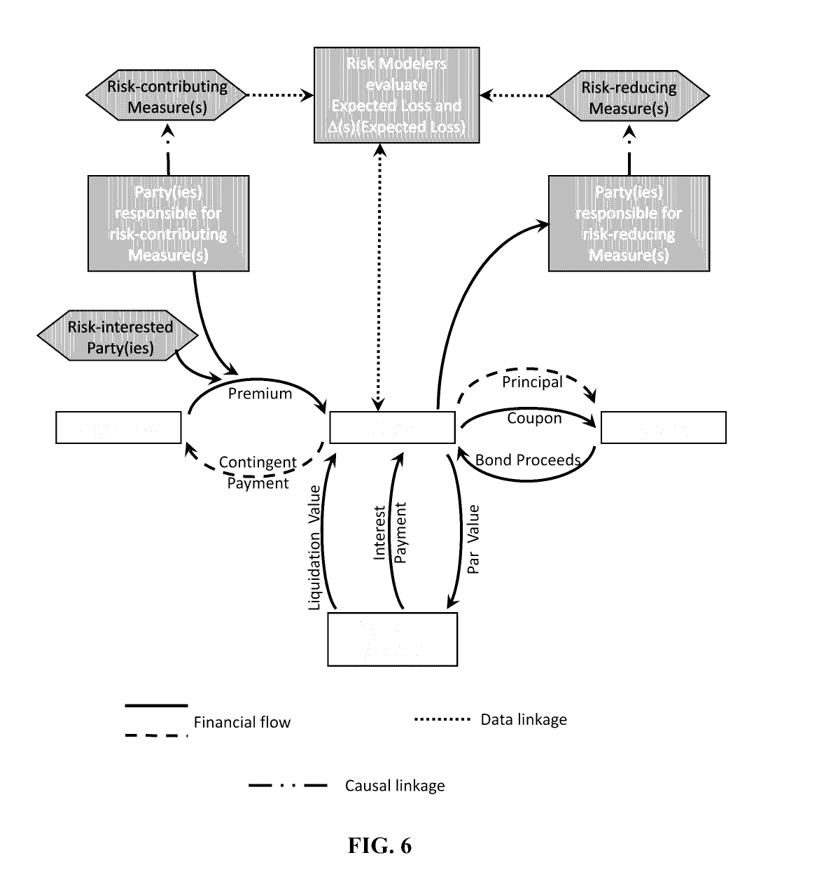

FIG. 6 illustrates an example structure for financial instruments, financial product(s), and/or financial transaction(s), based in part on the structure of conventional Cat-Bond instruments, to provide financial feedback mechanisms to parties potentially responsible for Risk-impacting Measures and to enable participation by Risk-interested Parties. The relations between parties appearing in both FIG. 3 and FIG. 6 are broadly similar. Key differences are in: (i) the data linkages among the Risk Modelers, Risk-impacting Measures, parties responsible for Risk-impacting Measures, and other parties to the instrument; (ii) explicit causal linkages among parties responsible for Risk-impacting Measures and the Measures themselves; and (iii) the financial linkages among the parties responsible for Risk-impacting Measures, the Risk-interested Parties, and the other parties to the instrument. These unique aspects enable and provide new financial feedback mechanisms and result from the novel products, systems, methods, and apparatuses disclosed here.

As illustrated in FIG. 6, Risk Modelers characterize the Expected Loss and/or financial risk reflected in the financial instrument for one or more baseline scenarios and for one or more scenarios with Risk-impacting Measures—including potentially both Risk-reducing Measures and Risk-contributing Measures—and further characterize the resulting differences in Expected Loss between the various scenarios (noted as “Δ(s)(Expected Loss)” in FIG. 6), referred to here as Risk Differentials. Note that this can be accomplished in a manner consistent with the example Risk Model framework illustrated in FIG. 1. In order to support these characterizations, Risk Modelers may collect data and information inputs related to the Risk-impacting Measures, define Specifications for the Measures from the collected data and information, characterize Risk Factors for the scenarios from the Specifications, and/or define risk model Parameter sets for the scenarios from the Risk Factor Characterizations, as discussed in relation to FIG. 2. Causal linkages are established between Risk-impacting Measures and one or more Parties that may be responsible for implementing or affecting the Measures, referred to here as Party(ies) potentially responsible for the Risk-impacting Measures. The combination of (i) these causal linkages between potentially responsible parties and the Risk-impacting Measures, (ii) the characterizations of Expected Losses and/or financial risks, and (iii) the differentials in these Expected Losses and/or financial risks provides a basis for financial linkages and/or feedback mechanisms between the potentially responsible parties and the other parties to the financial instruments, financial products, and/or financial transactions.

As noted above, the volumes of data considered within risk models used by Risk Modelers, the complexity of computations employed by such risk models, and/or the number of iterative calculations run in operating such risk models—and/or otherwise required to effectively characterize expected losses and expected loss differentials—generally causes it to be impractical if not impossible for such risk models—and therefore associated methods, systems, and apparatuses employing or otherwise relying on such risk models—to be implemented independently from a machine and/or computing environment.

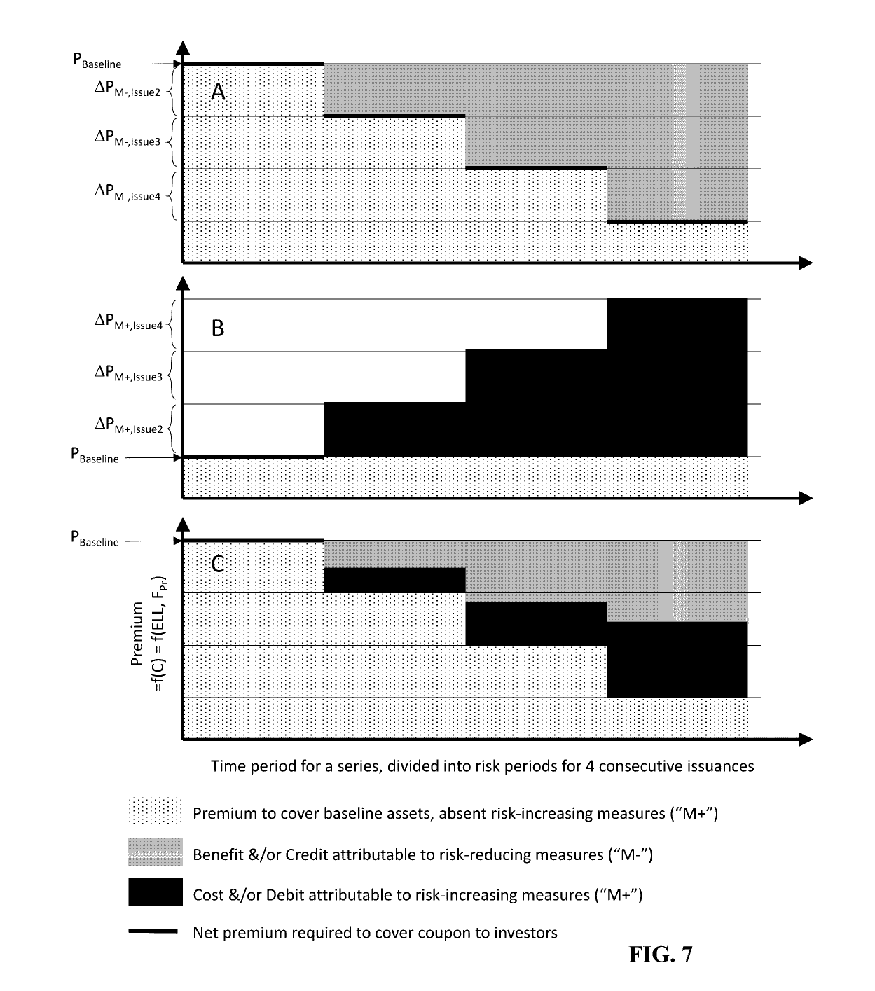

As illustrated in FIG. 6, Party(ies) potentially responsible for Risk-contributing Measures and/or various potential Risk-interested Parties each contribute to Premium payments by the Sponsor. In addition, the Issuer of the financial instrument(s) makes payments to Party(ies) potentially responsible for Risk-reducing Measures. The values of these respective payments, both absolute values and relative values, can be determined and/or allocated in a variety of ways, depending on the interests of the parties. An example of this determination is summarized below and is described in greater detail with respect to FIG. 7. It should be appreciated that other approaches and mechanisms are possible within the scope of the example structure illustrated in FIG. 6 and/or within the scope of other financial instruments leveraging the key mechanisms disclosed.

For example, payments to Party(ies) potentially responsible for Risk-reducing Measures can take several different forms. In some embodiments, these payments are structured as side payments directly or indirectly from the instrument's Sponsor(s), from Risk-interested Party(ies), from Party(ies) potentially responsible for Risk-contributing Measures, or from a combination of these and potentially other parties to the instrument(s) and/or transaction. In this case, the value of the Premium paid to the issuer for the issuance, or for subsequent issuances in a series, is reduced to reflect (i) the reduced rate of return required by Investors due to the reduced Expected Loss and/or reduced financial risk resulting from the Risk-reducing Measure(s)—including in the case of parametric triggers, for example, reduced Expected Losses and/or financial risk resulting from a change in the parameter value specified as the Trigger Event due to changes in the expected losses or damages associated with a particular parameter value—and/or (ii) the side-payment(s).

In other embodiments, for example, the Premium(s) paid by Sponsor(s), Risk-interested Parties, and/or Party(ies) potentially responsible for Risk-contributing Measures reflect the Premium required to compensate by investors for the Expected Loss and/or financial risk reflected in the instrument in the absence of the Risk-reducing Measures. This approach is well justified, for example, if this reflects the actual Expected Loss and/or financial risk at the initial issuance of an instrument, a series of instruments, and/or a program of issuances because, for example, the Risk-reducing Measures are implemented after the initial issuance. In some such embodiments, the issuer pays to, or otherwise provides a financial credit to the account(s) of, the Party(ies) potentially responsible for Risk-reducing Measures an amount proportional to the difference between the Premium collected (from the Sponsor(s), Risk-interested Parties, and Party(ies) potentially responsible for Risk-contributing Measures) and the Coupon required by Investors.

In other such embodiments, the Coupon paid to Investors reflects the full value of the Premium(s) collected, which can be greater than the Coupon required to compensate Investors for the risk being accepted after Risk-reducing Measures have been implemented. In such cases, the value of the instrument to Investors is greater than the instrument's Par Value, because the Coupon reflects a rate of return greater than Investors require. As a result, Investors pay more than, and/or Bond Proceeds may otherwise exceed, the Par Value of the instrument. An amount proportional to the difference between the Bond Proceeds and the Par Value is then paid to or otherwise provided as a financial credit to the account(s) of the Party(ies) potentially responsible for Risk-reducing Measures.

Thus, at least three means exist by which payments and/or financial credits are provided to Party(ies) potentially responsible for Risk-reducing Measures: Side payments from Sponsors, Risk-interested Parties, and/or Party(ies) potentially responsible for Risk-contributing Measures; Payments from the Issuer based on the difference between Premiums received and Coupons required; and direction of Proceeds received in excess of the Par Value. It should be appreciated that other means are also possible that leverage the basic feedback mechanisms and/or underlying data and are within the scope of the methods and systems described herein.

The value of payments and/or financial credits allocated to Party(ies) responsible for Risk-reducing Measures can be proportional to the reduction in Expected Loss and/or financial risk resulting from implementation of the Risk-reducing Measure. For example, if the Expected Loss or probability of a Trigger Event is reduced by 0.5% as a function of a Risk-reducing Measure, and if the Pricing Multiple for this change in Expected Loss is 4, then a value equivalent to or proportional to the product of 0.5%, 4, and the Par Value of the instrument is paid to or otherwise credited to the account(s) of the Party(ies) potentially responsible for the Risk-reducing Measures. As noted above, such payments and/or financial credits can be provided as side payments from the Sponsor(s), Risk-interested Parties, Party(ies) potentially responsible for Risk-contributing Measures, or a combination thereof; they can be provided by the Issuer based on the difference between the Premium(s) collected and the Coupon payments required, which may be similar to the result of the calculation described above; or they can be provided from the difference between the Bond Proceeds collected and the Par Value required to be deposited in the Collateral Account, which is proportional to the result of the calculation described above, but also accounting for the discount rate of investors, among other factors. This is consistent with the discussion of the Pricing Multiple provided in reference to FIG. 3, and therefore the pricing conventions established in markets for financial instruments similar to conventional Cat-Bonds. Pricing conventions from markets for other types of financial instruments can be similarly adapted to the financial feedback mechanisms disclosed here.

Similarly, a portion of the Premium required to compensate Investors for the risk they are accepting can be collected from, debited from, or otherwise allocated to the Party(ies) potentially responsible for Risk-contributing Measures. The portion of the Premium is proportional to the increase in Expected Loss and/or financial risk resulting from the Risk-contributing Measures. For example, if the Expected Loss, or probability of a Trigger Event occurring during the risk period of the financial instrument, is increased by 0.5% as a function of the Risk-contributing Measures, and if the Pricing Multiple for this change in Expected Loss on the financial instrument for is 4, then a portion of the Premium equivalent to or proportional to the product of 0.5%, 4, and the Par Value of the instrument is assessed to, collected from, or debited from account(s) of, the Party(ies) potentially responsible for the Risk-contributing Measures. This is consistent with the discussion of the Pricing Multiple provided in reference to FIG. 3, and therefore the pricing conventions established in markets for financial instruments similar to conventional Cat-Bonds. Pricing conventions from markets for other types of financial instruments can be similarly adapted to the financial feedback mechanisms disclosed here.

In some embodiments, the value of payment(s) for Premium(s) or Premiums plus side payments paid with respect to the financial instrument are based on the Expected Loss and/or financial risk that exist or that would exist, as characterized by Risk Modelers, for example, without the implementation—or without the full implementation—of one or more Risk-reducing Measures. In some embodiments, this basis for characterizing the Expected Loss and/or financial risk can be applied to a single issuance of financial instruments or to a series of issuances of financial instruments issued and re-issued periodically over time. In such cases, the Coupon required by Investors—in absolute or relative terms—decreases over time with the implementation of Risk-reducing Measures, all else being equal. Such a reduction in the Coupon requirement results in a reduction of the Premium required to be paid by Sponsor(s), all else being equal. This forms the basis for the payments and/or financial credits to be allocated to the Party(ies) potentially responsible for Risk-reducing Measures, as discussed above.

In various embodiments, the Premium required to sponsor the financial instrument and the difference between the premium indicated by the Expected Loss without Risk-reducing Measures and the premium required to sponsor the financial instrument after implementation of Risk-reducing Measures is variously allocated between the Sponsor(s), who receive the benefit of the risk transfer provided by the instrument, Party(ies) potentially responsible for Risk-contributing Measures, and various potential Risk-interested Parties. As noted above, for example, the portion of the Premium attributable to Risk-contributing Measures, referred to as a Risk-contribution Premium Differential, is allocated to the Party(ies) potentially responsible for the Risk-contributing Measures. For example, in the case of instruments transferring risk associated with catastrophic flooding events, this can be debited from a fund containing monies collected via a tax on greenhouse gas emissions in proportion to the Risk-contributing Premium Differential resulting from the increase in atmospheric and sea-surface temperatures caused by elevated greenhouse gas concentrations associated with the emissions. Alternatively, this portion of the Premium can be paid by the Sponsor or a Risk-interested Party.

The difference between the Premium indicated by the Expected Loss without Risk-reducing Measures and the potentially lower Premium required after Risk-reducing Measures are implemented, referred to here as a Risk-reduction Premium Differential, can also be allocated in various ways. It is worth noting in this context that the Risk-reduction Premium Differential can provide the basis for payments and or other financial credits for the benefit of Party(ies) potentially responsible for Risk-reducing Measures, and therefore can be viewed as providing funds to support implementation of Risk-reducing Measures. In some embodiments, the Risk-reduction Premium Differential can be fully allocated to and paid by the Sponsor.

In other embodiments, the Risk-reduction Premium Differential (reflecting the financial benefits of Risk-reducing Measures) can be allocated to, or debited from accounts of, Party(ies) potentially responsible for Risk-contributing Measures. Such embodiments are viewed as enabling Party(ies) contributing to the risk to provide funding in support of Measures that reduce or otherwise mitigate the risk. The ability to effectively allocate costs for reducing risks to parties contributing to risks is important in a variety of contexts.

In other embodiments the Risk-reduction Premium Differential (reflecting the financial benefits of Risk-reducing Measures) can be allocated to, or debited from accounts of, Risk-interested Parties. For example, parties with an interest in providing funding to support risk reductions and/or development of risk reduction strategies can commit to fund this Premium Differential. This is particularly relevant to sources of funding aimed at mitigating risks, advancing risk reductions, and/or advancing particular Risk-reducing Measures, for example, which relate to a program for distributing and/or otherwise managing such funds.

It will be understood by those experienced in the arts of structured finance, structured financial instruments, and financial risk transfers that the processes and elements illustrated in FIG. 6 may be integrated, aggregated, disaggregated, and/or embodied into other products and/or instruments in various ways, as is convenient and/or practical, to achieve the intended function. The example provided in FIG. 6 is structured as illustrated for clarity of disclosure and represents one embodiment for implementing the techniques described herein.

FIG. 7 provides a simplified illustration of Premiums and Premium Differentials for a series of four issuances of financial instruments. Time is plotted on the horizontal axis and reflects four consecutive issuances in a series of financial instruments or four consecutive series of instruments issued within a program of issuances. Premiums and Premium Differentials for Expected Losses and Expected Loss Differentials associated with each of the four issuances are plotted on the vertical axis. Note that each level of Premiums and Premium Differentials appear to be constant over time and across multiple issuances or series of issuances in time; however this reflects a simplification of the figure. As noted above, Premiums (and Premium Differentials) for multiple issuances or series of a financial instrument may change over time due to changes in underlying risk factors that are unrelated to the Measures of interest and/or due to changes in investor risk preferences and/or market conditions, which may be represented in changes in the Pricing Multiple demanded for any given level of risk or Expected Loss, for example.

Panel “A” illustrates a scenario in which increasing implementation of Risk-reducing Measures over time lowers the Premium required to compensate Investors in each successive issuance in the series. The net Premium required to sponsor each issuance is indicated with the heavy horizontal line. The Risk-reduction Premium Differential realized between the first and second issuances is labeled “ΔP_{M-, Issue2}”. The incremental Risk-reduction Premium Differentials realized between the second and third issuances and between the third and fourth issuances are labeled “ΔP_{M-, Issue3}” and “ΔP_{M-, Issue4}”, respectively. The area below the net Premium lines, with a dotted pattern, represents the aggregate cost to the sponsor if the Risk-reducing Measures are implemented independently from a financial instrument, without feedback mechanisms described here and/or without any of the associated financial incentives for implementation. The area between the level of the baseline Premium (labeled “P_{Baseline}”) and the net Premium lines, shaded gray, represents the aggregate financial benefit from the Risk-reducing Measures, or the aggregate Risk-reduction Premium Differential. Assuming that some combination of the Sponsor, Risk interested Parties, and Party(ies) potentially responsible for Risk-contributing Measures commit to pay Premiums equivalent to the Premium required before implementing the Risk-reducing Measures, labeled “P_{Baseline}” in FIG. 7, Panel A, then the area above the net Premium lines represents the aggregate value of payments or other financial credits benefiting Party(ies) potentially responsible for Risk-reducing Measures. As noted above, this can be structured in a variety of ways, including, for example: as side payments from the Sponsor(s), Risk-interested Parties, and/or Party(ies) potentially responsible for Risk-contributing Measures; as payments from the Issuer in proportion to the difference between Premium(s) collected and Coupon Payments required; as payments of Bond Proceeds in excess of the instrument's Par Value; and/or it can be structured in other ways that achieve similar effect.

Panel B illustrates a scenario in which increasing implementation of Risk-contributing Measures over time increases the Premium required in each successive issuance in the series. The net Premium required to sponsor each issuance is again indicated with the heavy horizontal line. The Risk-contribution Premium Differential realized between the first and second issuances is labeled “ΔP_{M+, Issue2}”. The incremental Risk-contribution Premium Differentials realized between the second and third issuances and between the third and fourth issuances are labeled “ΔP_{M+, Issue3}” and “ΔP_{M+, Issue4}”, respectively. The horizontal line beginning at net Premium line for the first issuance reflects the Premium required before Risk-contributing Measures are implemented and is labeled “P_{Baseline}”. The area below reflects the total cost to sponsor the instrument if the Risk-contributing Measures are not implemented and has a dotted pattern. This area represents the aggregate cost to the sponsor if the Risk-contributing Measures are not implemented at all, or if the Risk-contribution Premium Differential are paid by, or debited from an account of, one or more of Risk-interested Parties and/or Party(ies) potentially responsible for the Risk-contributing Measures. The area between the horizontal line labeled “P_{Baseline}” and the net Premium lines for the subsequent issuances in the series, shaded black, represents the aggregate financial cost attributable to the Risk-contributing Measures, or the aggregate Risk-contribution Premium Differential. Assuming that some combination of Risk-interested Parties and Party(ies) potentially responsible for Risk-contributing Measures commit to pay Premiums equivalent to the Risk-contribution Premium Differential in FIG. 7, Panel A, then this area represents the net payments from these parties required, in addition to the baseline premium paid by the Sponsor, in order to compensate Investors for the financial risk they are accepting. In cases where this payment is made by, or debited from an account of, one or more Party(ies) potentially responsible for the Risk-contributing Measures, then this area represents the aggregate value of incentives to mitigate the Risk-contributing Measures.

Panel C illustrates a scenario in which increasing implementation of both Risk-contributing and Risk-reducing Measures impact the net Premiums over time. The heavy horizontal lines reflect the net premium required to compensate Investors. The area having a dotted pattern represents the aggregate cost attributable to the Sponsor in the absence of Risk-contributing Measures, or in cases where the Risk-contribution Premium Differentials and Risk-reduction Premium Differentials are paid by, or debited from accounts of, some combination of Risk-interested Parties and Party(ies) potentially responsible for Risk-contributing Measures. The Risk-contribution Premium Differentials are shaded black and represent the portions of Premiums that may be attributed to Risk-contributing Measures and Party(ies) potentially responsible for Risk-contributing Measures. The Risk-reduction Premium Differentials are shaded gray and represent the financial benefits that may be attributed to Risk-reducing Measures and Party(ies) potentially responsible for Risk-reducing Measures.

Note that the illustration in Panel C reflects a case in which the Risk-contributing Premium Differential partially offsets the Risk-reducing Premium Differential and the net premium decreases with each successive issuance. It is possible that Risk-contributing Premium Differentials can fully offset Risk-reducing Premium Differentials, so that the net premium remains equal for successive issuances (all else being equal). It is also possible that Risk-contributing Premium Differentials can more than offset Risk-reducing Premium Differentials, so that the net premium increases for successive issuances, despite the Risk-reducing Measures (all else being equal).

In some embodiments, Sponsors commit to pay Premiums for a single issuance or a series of issuances at a level equivalent to that required absent the implementation of any Risk-reducing Measures, as indicated by the horizontal line labeled P_{Baseline} in FIG. 7, Panel A. This can reflect, for example, an interest by the Sponsor in both transferring financial risks to Investors and in advancing implementation of Risk-reducing Measures, which may mitigate physical risks (in addition to financial risks) to which the Sponsor is exposed.

As discussed above, however, in other embodiments, the Premiums and Premium Differentials are paid by, or debited from accounts of, other relevant parties. In this context, it is noteworthy that parties can commit to fund Risk-reduction Premium Differentials as a means of providing arms-length funding to Measures that deliver quantifiable risk reductions. The sources of such funding do not need to design, develop, or qualify Measures themselves. By simply committing to fund the Risk-reduction Premium Differentials, Risk-interested Parties can create incentives for any party able to develop and implement Measures that provide measurable risk reductions. Similarly, parties can commit to fund Risk-contribution Premium Differentials as a means of providing arms-length compensation for quantifiable risks imposed by Risk-contributing Measures. The sources of such funding do not need to be otherwise involved in the transaction, financial instrument, or associated risk transfer.

Consider, for example, a scenario in which a Sponsor commits to pay the net Premiums, indicated by the heavy horizontal lines in FIG. 7, Panel A, and Risk-interested Parties commit to fund the Risk-reduction Premium Differential as a means of providing arms-length support for Measures that deliver quantifiable risk reductions. This enables the following series of events, for example: developers of Risk-reducing Measures can provide data and information regarding their Measures to one or more Risk Modelers that are acceptable to the Issuer, Sponsor, Risk-interested Parties, and the Investor community; the Risk Modelers can use that information to characterize the Measures' impacts on Expected Losses (e.g., by defining Specifications for the Measures, characterizing Risk Factors for one or more baseline scenarios and scenarios with Measures, defining Parameter sets for these scenarios and running risk models for these scenarios, as discussed in reference to FIGS. 1 and 2, for example); Investors can validate the modeled risk reduction by accepting a reduced Coupon, reflecting the reduced risk they are accepting, all else being equal; the net Premium charged to the Sponsor can be reduced accordingly, all else being equal, and/or a Risk-reduction Premium Differential can be otherwise specified (e.g., as discussed above); the resulting Risk-reduction Premium Differential can be charged to or debited from an account of the Risk-interested Parties; and a value proportional to the Risk-reduction Premium Differential may be paid to or credited to an account of the Party(ies) potentially responsible for the Risk-reducing Measure, or the Measures' developer(s) in this case.

In this example scenario, and other similar examples, neither the Sponsor, nor the Issuer, nor the Investors, nor the Risk-interested Party, nor the Risk-contributing Party(ies)—in scenarios involving Risk-contribution Risk premiums and/or in scenarios in which Party(ies) potentially responsible for Risk-contributing Measures commit to fund the Risk-reduction Premium Differential—need to be involved in designing or developing the Risk-reducing Measures. Risk Modelers can characterize the risk reductions using data & information from the Measures' developer(s) in terms of net impacts on Expected Losses and financial risks of the financial instruments; Investors and related capital markets can validate the net reduction in Expected Losses through the purchase of the financial instruments at prices appropriate for the reduced Expected Losses. The only information required by the Risk-interested Party with an interest in supporting Risk-reducing Measures is the resulting Risk-reduction Premium Differential to which the Risk-interested Party has committed.

This provides a system, method, and apparatus for distributing or otherwise managing funds intended to advance risk reductions. The system integrates components illustrated in FIG. 6 to enable efficient distribution of funds to Party(ies) responsible for implementing Measures that deliver risk reductions that are quantified by Risk Modelers and validated by Investors. In such a system, the Risk-interested Parties identified in FIG. 6 and in the discussion above represent the source and/or managers of funds intended to advance risk reductions. This system and method can be implemented through a single issuance or series of issuances of financial instruments, thereby providing multiple opportunities to quantify and direct benefits of Risk-reduction Premium Differentials to Party(ies) responsible for Risk-reducing Measures.

The system and method can further be implemented on a computing device and/or machine apparatus. The apparatus may receive inputs providing combinations of: (i) information regarding the financial instruments employed to implement the program, system and method; (ii) specifications for proposed Risk-reducing Measures; (iii) information regarding Pricing Multiples; and/or (iv) financial allocation rules. The apparatus can provide outputs of: expected or actual Risk Profiles, Risk Profile Differentials, Expected Losses, Expected Loss Differentials from Risk Modeling; pricing for Coupons, Premiums, and Premium Differentials; and (iii) financial credits and/or debits attributable to Party(ies) responsible for Risk-reducing Measures.

Similarly, this provides a system and method for providing financial incentives to mitigate Risk-contributing Measures. The system integrates components illustrated in FIG. 6 to enable efficient allocation of financial debits among Party(ies) responsible for implementing Measures that contribute to risks in ways that are quantified by Risk Modelers and validated by Investors. This system and method can be implemented through a single issuance or series of issuances of financial instruments, thereby providing multiple opportunities to quantify and direct the costs associated with Risk-contribution Premium Differentials to Party(ies) responsible for Risk-contributing Measures.

The system and method can be further implemented on a computing device and/or machine apparatus. The apparatus can receive inputs providing combinations of: (i) information regarding the financial instruments employed to implement the program, system and method; (ii) specifications for Risk-contributing Measures; (iii) information regarding Pricing Multiples; and/or (iv) financial allocation rules. The apparatus can provide outputs of: expected or actual Risk Profiles, Risk Profile Differentials, Expected Losses, Expected Loss Differentials from Risk Modeling; pricing for Coupons, Premiums, and Premium Differentials; and (iii) financial credits and/or debits attributable to Party(ies) potentially responsible for Risk-contributing Measures.

In establishing financial incentives to reduce or otherwise mitigate risks related to particular physical risk factors, and for other related reasons, it is useful to establish Factor-contingent Financial Instruments. The term Factor-contingent Financial Instrument is used here to describe financial instruments capable of recognizing—e.g., through financial flows, payments, credits, and/or debits—the financial impacts of various types of Measures that affect potential risk factors. They may be structured in a manner consistent with the example illustrated in FIG. 6 or structured in various other ways that achieve similar objectives.

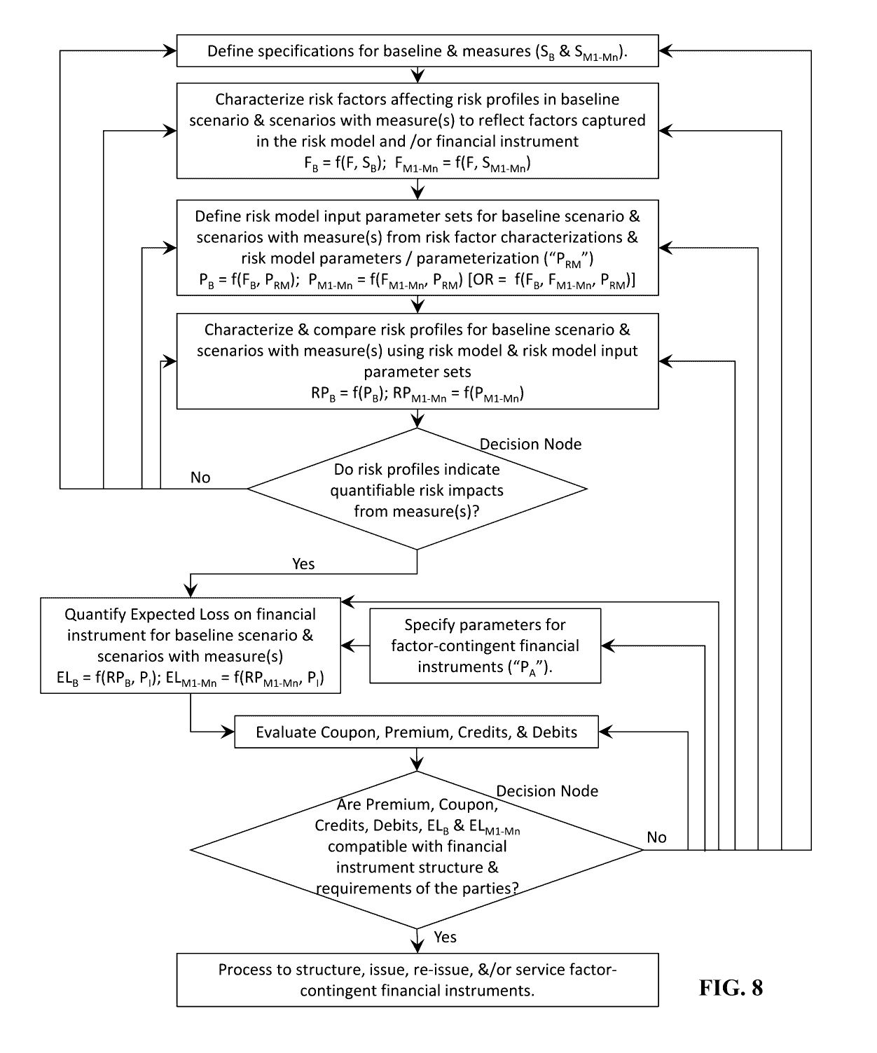

FIG. 8 illustrates an example process flow, method, system, and/or apparatus to design, characterize, and evaluate risk impacts from Measures and Factor-contingent Financial Instruments. Note that the example process flow is described in the context of a Factor-contingent Financial Instrument; however, it can actually be employed in a variety of contexts.

As illustrated, the example process begins with a process of defining specifications for the Baseline(s) and the Measures of interest, “M1” through “Mn”. In FIG. 8, the specifications for the Baseline(s) are indicated with the variable “S_{B}”, and the specifications for the Measures are indicated with the variable “S_{M1-Mn}”. Specifications may take a variety of forms, including but not limited to engineering design specifications. Examples of such Specifications can include the dimensions, locations, construction materials, and other related specifications for seawalls, levees, or other water diversion Measures. Other examples can include the location, holding capacity, flow capacity, and/or pumping capacity of storm water storage and/or enhanced drainage systems. Other types of Specifications for other types of measures can include, but are not limited to: effluent rates and/or emissions rates; land zoning rules, building codes and enforcement provisions; and the extent, timing and dimensions of beach, reef, and/or mangrove enhancement activities. The above examples are largely related to flooding risk; it should be appreciated that Measures impacting other types of risks are naturally associated with other types of Specifications. Specifications for the Baseline(s) can reflect specifications in the absence of the Measures, or can reflect specifications for an alternate baseline or business-as-usual (i.e., without Measures) scenario in which the Measures are substituted with some other set of developments and/or activities.

The Specifications, S_{B} and S_{M1-Mn}, can be used as inputs to a process characterizing sets of risk factors (which affect risk profiles) for one or more baseline scenarios and one or more scenarios with Measures impacting the risk factors. The risk factor characterizations for the baseline scenario(s), identified in FIG. 8 with the variable “F_{B}”, and for the scenario(s) with Measures, identified in FIG. 8 with the variable “F_{M1-Mn}”, represent the states of relevant risk factors for the baseline scenario(s) and the scenarios with Measures, respectively. They are designed to reflect the specification(s) for the baseline scenario(s) and scenarios(s) with Measures, the risk factors captured in the Risk Model (discussed below) and the contingent risk factors captured in the Factor-contingent Financial Instrument, as appropriate.

The factor characterizations, F_{B} and F_{M1-Mn}, may be used as inputs to a process defining risk model input parameter sets for the one or more baseline scenarios and one or more scenarios with Measures. The parameter sets for the baseline scenario(s) and scenarios with Measures are identified in FIG. 8 with the variables “P_{B}” and “P_{M1-Mn}”, respectively. The parameter sets represent the input information, data, and/or values required to operate the risk model for each of the various scenarios. As such, they are designed to reflect the risk factor characterizations for the various scenarios, F_{B} and F_{M1-Mn}, and the parameter inputs, or parameterization, of the risk model.

The sets of risk model input parameters, P_{B} and P_{M1-Mn}, may be used as inputs to a risk modeling process that characterizes risk profiles associated with the one or more baseline scenarios and one or more scenarios with Measures. The risk profiles for these scenarios are identified in FIG. 8 with the variables “RP_{B}” and “RP_{M1-Mn”,} respectively. The risk profile characterizations, RP_{B} and RP_{M1-Mn}, can take a variety of forms. Examples include but are not limited to probability distributions, ranges, point estimates, and/or probabilities for reaching threshold values for potential damages, losses, indemnified losses, indices, events, and/or event types. The risk profiles can be characterized using a wide variety of models, modeling tools, techniques, methods, systems, apparatuses, data, and/or information sources. Accordingly the risk modeling process can be comprised of a wide variety of systems and/or sub-systems, can incorporate a wide variety of exogenous sources and/or systems, and can be implemented through a wide variety of apparatuses, including but not limited to computer implementations. The details of risk modeling processes are not disclosed here beyond the level required for integration within the broader content of the invention.

The risk profile characterizations can include discrete characterizations for each scenario, characterizations that integrate across scenarios, and/or characterizations of the differences between the scenarios, depending on the specific purpose, structure and/or design of the implementation.

The risk modeling process can be followed by a Decision Node in which various qualities of the risk profile characterizations are evaluated. Qualities that can be evaluated include but are not limited to the absolute measures generated in the characterizations, the significance (e.g., statistical significance) of the measures generated, the deviations between various scenarios and/or combinations of scenarios, and/or the suitability of the characterizations for the intended purpose, structure, and/or design of the implementation. This Decision Node is labeled in FIG. 8 with the question: “Do risk profiles indicate quantifiable risk impacts from measure(s)?”, which is intended to represent an example of how this Decision Node can be framed. Consistent with the discussion presented here, this Node can be framed in a wide variety of ways, can be structured around a wide variety of other types of questions that are relevant to answer, and/or can be otherwise qualified to proceed to the next step in the process.

If the evaluation of the risk profiles indicates that the profiles are in some way not qualified to proceed, the risk profiles can be used as a basis to revisit any combination of the preceding steps in the process. For example, the risk profiles can suggest that the Specifications, risk factor characterizations, risk model parameter sets, and/or the risk modeling process require modifications, refinement, or reconsideration in order to produce risk profiles that are suitable, qualified, and/or sufficient for the intended purpose, structure, and/or design of the implementation. This pathway is indicated in FIG. 8 by the pathway labeled “No” in response to the example question framed in the Decision Node. Note that changes made to any of the processes revisited as a function of a negative determination in the decision node generally require re-iteration of subsequent processes up to the Decision Node. This iterative process can be repeated any number of times until the decision rules embodied in the decision node are satisfied and/or the risk profile characterizations are deemed sufficient, suitable, and/or acceptable to proceed to the next step in the process, which is indicated in FIG. 8 by the pathway labeled “Yes” in response to the example question framed in the Decision Node.

Risk profile characterizations that satisfy the decision node can be used as inputs to a process to quantify the economic implications of the risk profiles for various agents, entities, communities, or for the public in general, and to quantify the financial implications of the risk profiles on one or more assets, instruments, options, revenue streams, programs, and/or contracts, including but not limited to Factor-contingent Financial Instruments, which is exemplified in FIG. 8. In the context of certain Factor-contingent Financial Instruments, it is convenient to quantify the financial implications of the risk profile characterizations in terms of Expected Losses on financial instruments for the various scenarios—e.g., one or more baseline scenarios and one or more scenarios with Measures—and in terms of Expected Loss Differentials—e.g., the differences in Expected Losses between the one or more baseline scenarios and the one or more scenarios with Measures. In some cases, for example cases with parametric trigger events, it can be convenient to specify the expected loss differential as a function of the change in the parameter trigger value after the Measures that yield a similar expected financial loss or damage, as noted above. In the context of Factor-contingent Financial Instruments with structures similar to the example illustrated in FIG. 6, the Expected Losses can reflect in part the probabilities of occurrence for one or more Trigger Events specified in the financial instrument.

Because the process to quantify financial implications of the risk profiles involves analyzing risk profile characterizations from the risk modeling process with respect to one or more agents, entities, communities, or general public and with respect to one or more assets, instruments, options, revenue streams, revenue-back financial instruments, programs, loans, loan-backed financial instruments, tax-revenues, tax-backed financial instruments, and/or contracts, collectively referred to here as “financial article(s)”, the process requires input parameters specifying key attributes of the economic characteristics of the agents, entities, communities, or general public and key attributes of the financial article(s) of interest. The set of parameters defined to specify key attributes of the financial article(s) of interest are identified in FIG. 7 with the variable “P_{A}”. In the context of Trigger Events specified in Factor-contingent Financial Instruments, as illustrated in FIG. 8 and discussed elsewhere herein, these parameter sets can include but are not limited to those characterizing Trigger Events, which causes all or a portion of the value embodied in Collateral Account(s) to be released to an instrument's Sponsor and therefore not returned to investors upon maturity.

Characterizations of the economic implications of the risk profiles and of the financial implications of the risk profiles for one or more financial article(s) can be followed by a process evaluating the impacts on one or more economic or financial values. These economic or financial values can include but are not limited to actual or estimated: coupon payments; premium payments; Risk-reducing Premium Differentials; Risk-contributing Premium Differentials; financial credits and/or deficits; market valuations for one or more financial articles; market valuations for real assets; market valuations for one or more real options; economic value of the measure(s); net benefits of the measure(s) considering both costs and benefits; cost effectiveness of the measure(s); and cost effectiveness accounting for financial credits and/or deficits associated with one or more financial article(s). As indicated in the example illustrated in FIG. 8, in the context of Factor-contingent Financial Instruments structured as illustrated in FIG. 7, the process of evaluating the impacts on one or more financial values can be conducted in a manner consistent with the discussions above regarding Premiums, Coupons, Risk-increasing and Risk-reducing Premium Differentials, and/or values attributable to Risk-reducing and/or Risk-contributing Measures.

In some embodiments, one or more of the process to quantify economic implications and financial implications of the risk profiles and the process to evaluate impacts on one or more economic or financial values are integrated with the process to characterize and compare risk profiles for the one or more baseline scenarios and the one or more scenarios with Measures.

In some embodiments, multiple scenarios with Measures may represent alternate levels of protection, design alternatives, engineering alternatives, construction alternatives, and/or other implementation alternatives, collectively referred to here as “implementation options” for the Measures. As a result, the one or more processes to quantify economic and/or financial implications of the Measures may characterize the relative merits of alternate implementation options. The relative merits of alternate implementation options may be used with various decision criteria to identify preferred and/or optimal implementation options. In some cases, these criteria may inform the identification and analysis of additional implementation options that had not been previously considered.

The process evaluating impacts on one or more financial values can be followed by one or more Decision Nodes. In some embodiments, a Decision Node may be used to evaluate whether these impacts are compatible with, consistent with, sufficient for, suitable for, and/or otherwise qualified for the intended purpose(s) of the overall process and/or associated interested parties. This Decision Node is labeled “Are Premium, Coupon, Credits, Debits, EL_{B} and EL_{M1-Mn} compatible with financial instrument structure and requirements of the parties?” in FIG. 8. In the context of Factor-contingent Financial Instruments, as in the example illustrated in FIG. 8, this process reflects an evaluation of whether Premiums, Coupons, Risk-increasing, and Risk-reducing Premium Differentials, and/or values attributable to Risk-reducing and/or Risk-contributing Measures are compatible with the structure of the Factor-contingent Financial Instrument and/or meets the requirements or expectations of Sponsor(s), Issuer(s), Investor(s), Risk-interested Parties, Party(ies) potentially responsible for Risk-contributing Measures, Party(ies) potentially responsible for Risk-reducing Measures, and/or other potentially interested parties or stakeholders.

If the determination of this Decision Node is an indication that the financial values are in any way not compatible with, consistent with, sufficient for, suitable for, and/or otherwise qualified for the intended purpose(s), as indicated by the pathway labeled “No” in FIG. 8, then this can cause any one or more of the proceeding processes to be revisited, revised, modified, or otherwise adjusted. Such iterative processing can be repeated as many times and in as many combinations of processes as necessary until the determination of this Decision Node is an indication that the financial values are compatible with, consistent with, sufficient for, suitable for, and/or otherwise qualified for the intended purpose(s).

In such embodiments, and upon a positive determination at such a Decision Node, the results generated through the course of the process are carried forward to a subsequent process. This can mark the completion of the process to design, characterize, and evaluate risk measures and Factor-contingent Financial Instruments, as illustrated in FIG. 8. It can mark a point of transition to one or more processes intended to structure, issue, re-issue, and/or service such financial instruments or related instruments. Alternatively, it can mark a point of transition to a variety of other processes that relate to the physical and/or financial risks, risk factors, and or risk profiles considered within the process flow.

In other embodiments, a Decision Node may be used to evaluate whether the economic values or implications of the Measures satisfy specific objectives or requirements for the Measures and therefore whether the Measures should be implemented at all. Examples of such objectives or requirements may include: minimum net benefit thresholds; minimum cost effectiveness thresholds; maximum cost limits; other limitations imposed by budgets or budget processes; thresholds or targets defined in terms of residual risk, risk remaining after implementation, or changes in risk exposure resulting from the measures; or any other available objective, requirement, or criteria.

If the determination of this Decision Node is an indication that the economic values or implications are in any way not compatible with, consistent with, sufficient for, suitable for, and/or otherwise qualified for the intended purpose(s), as indicated by the pathway labeled “No” in FIG. 8, then this can cause any one or more of the proceeding processes to be revisited, revised, modified, or otherwise adjusted. This includes revisiting the specification of the Measures overall, which could cause implementation of the Measures to be reconsidered, deferred, put on hold, terminated, substantially re-envisioned, de-prioritized, de-selected, or otherwise reconsidered. While this path is not explicitly illustrated in FIG. 8, it provides a means for the identification, selection, elimination, or screening of proposed Measures, or for other decisions related to initiatives to develop Measures.

Upon a positive determination at such a Decision Node, the Measures may proceed to implementation or to the next stage in a broader implementation or development process. Such determinations can therefore have fundamental impacts on whether and which physical risk reduction Measures are implemented, which can have profound effects on exposures to physical risks.

In other embodiments, a Decision Node may be used to select the preferred or optimal implementation option(s) from the various implementation options evaluated according to their relative economic values or implications. As noted above, implementation options may be differentiated according to their designs, engineering, construction, levels of protection, or other aspects, variables, qualities, characters, processes, or disciplines. As a result, the output of such a Decision Node will determine and directly impact the physical design, engineering, construction, level of protection, and other aspects of the physical embodiment of Measure(s) implemented. For example, it may be applied to define the height of coastal protection barriers, the capacity of storm water drainage and detention systems, the thickness of walls, the depth of foundations, the types of reinforcements, the size of pumping systems, the capacity of thermal management systems, the construction materials or methods used, and/or the level of protection achieved.

As such, an engineering plan to design and/or construct the physical embodiments can be generated to implement the physical embodiments at a particular geographic location. For example, the server computing device 506 can evaluate the financial, technical, and other data associated with the implementation plan and provide a specification, drawings, budgetary documentation and other types of action plan information to design, construct and otherwise implement the physical embodiments that impact the risk and risk mitigation described herein.

Many of these physical characterizes of buildings, infrastructure, and risk reduction Measures are currently determined by generalized codes or standards that do not directly reflect the economic and financial implications or impacts. The process described here, and the present invention more broadly, enables key physical aspects of risk reduction Measures to be defined and implemented according to economic benefits or values, which can provide more robust physical protections than are implied by established codes, standards, or requirements.

Results generated throughout the process flow are embodied in one or more data and/or information products. These products are valuable for informing decisions regarding financial instruments, financial articles, options, programs, initiatives, assets, measures, and/or the design, engineering, construction, or implementation of risk reduction Measures. Results generated throughout the process flow, and/or associated products, can be embedded within or otherwise contribute to a process, method, system, and/or apparatus to distribute and/or manage funds intended to advance risk reductions, as discussed in the context of Risk-interested Parties and FIGS. 6 and 7 above. Similarly, the results can be embedded within or otherwise contribute to a process, method, system, and/or apparatus to quantify or otherwise manage incentives to mitigate risk-contributing activities, as also discussed above.

As noted above with respect to risk models, the volumes of data considered, the complexity of computations employed, and/or the number of iterative calculations run in conducting various of the processes described in the process flow illustrated in FIG. 8 generally causes it to be impractical if not impossible for such processes—and therefore associated methods, systems, and apparatuses employing or otherwise relying on such processes—to be implemented independently from a machine and/or computing environment. Technical aspects of these models are therefore disclosed here only with sufficient detail to characterize their integration and application within the methods, systems, and apparatuses that comprise the primary subjects of the current disclosure.

It will be understood by those experienced in the arts of risk modeling, risk quantification, option pricing, and/or pricing of other assets or instruments that the processes illustrated in FIG. 8 can be integrated, aggregated, disaggregated, and/or embodied into other processes in various ways, as is convenient and/or practical, to achieve the intended function. The example provided in FIG. 8 is structured as illustrated for clarity of disclosure and represents one embodiment for implementing the techniques described herein.

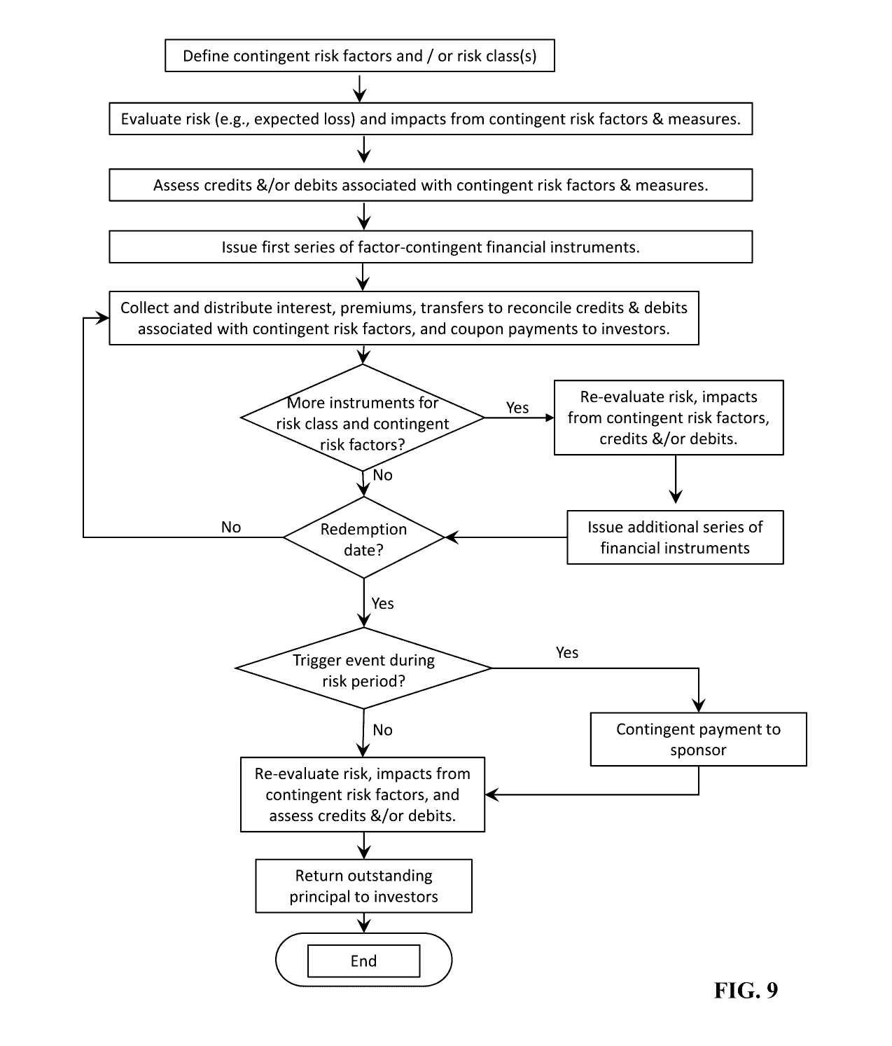

FIG. 9 illustrates a process flow to structure, issue, re-issue, and/or service recurringly issuable factor-contingent financial instruments. This provides, among other things, a method of securitizing natural or human catastrophe risk and risk reduction measures and/or contribute to a method of distributing funds to advance risk reductions using a program of factor-contingent financial instrument transactions. To begin the method, one or more contingent factors and/or risk classes are established. Potential Measures that can impact the risk factors are also identified in this step. Each class can represent the risk of occurrence of one or more natural or human catastrophe events of a particular type, or a combination of types, in a particular region or regions during a risk period. Each contingent factor can represent a factor affecting the occurrence of the catastrophe event and/or a factor affecting the realization of damages and/or losses from the catastrophe event. The risk classes and risk factors can be established by a sponsor, which represents the owner of an asset exposed to the risk class, an insurer, a reinsurer, a corporation, an organization, an entity, and/or individual or group of individuals seeking to secure coverage for the represented risks. Alternatively, the risk classes and contingent factors can be established by an issuer, or another party interested in the set of transactions and/or financial instruments.

Establishing risk class(es) and contingent factor(s) can include defining class and factor terms that remain relatively constant across multiple issues during the course of the program and/or during the period over which the instruments are recurringly issued. Class terms can include, but are not limited to, terms specifying the actual risk or risks covered by each class, parametric indicies, Trigger Events, and/or other terms used to determine if and when a Trigger Event has occurred, modeling of expected losses, financial ratings, and/or other terms relevant to specifying the risk. Contingent factors can include any factor impacting the likelihood of occurrence of a catastrophic event within the risk class and/or a Trigger Event related to the risk class, as discussed above. Identifying potential Measures can include specifying project types, project specifications, project locations, and/or any other term or terms that are used to qualify Measures for consideration within the program. Alternatively, potential Measures may not be specifically identified, in which case thresholds for impacts on contingent factors and/or other terms may be specified to qualify proposed Measures for consideration within the program.

The established risk class(es) and contingent factor(s) can be used to evaluate risks, risk profiles, expected loss(es), and/or differentials associated with the contingent factors and potential Measures. This can be conducted in manners consistent with the discussions above regarding FIGS. 1, 2, 6, 7, and/or 8. As discussed above in the context of those figures, it is generally impractical and/or impossible to conduct these evaluations outside a machine and/or computing environment.

Financial credits and/or debits are then assessed with respect to the contingent factors and potential Measures. Again, this can be conducted in a manner consistent with the discussions above regarding FIGS. 1, 2, 6, 7, and/or 8. It may also be impractical and/or impossible for these assessments to be accomplished outside a machine and/or computing environment.

A first collection of risk instruments of the risk class(es) and contingent factor(s) are then issued by an Issuer. The issuer can be a reinsurer, a bankruptcy-remote or special purpose entity, or another entity suitable to the duties and responsibilities of issuing and potentially servicing financial instruments. One or more sets of terms can be established for the first collection of instruments at the time of issuance. These terms can specify the timing, market conditions, risk period, coupon and/or coupon spread, and maturity date, for example. Certain terms associated with the series and/or program are also updated at the time of issuance, including but not limited to the risk modeling results, expected losses, expected loss differentials, premium(s), premium differentials, coupon(s), credits, debits, and/or investment ratings associated with particular issuances. Some terms can be updated or otherwise altered regularly or periodically at times that do not coincide with the issuance or re-issuance of instruments in the program. The issued instruments can be sold or otherwise distributed to investors by a dealer, broker, agent, sponsor, or issuer individually or in any combination.

Proceeds received from investors, generally in an amount equal to the par value of the instruments, can be placed in a collateral account and invested in qualified investments, for example investment types with minimal risk of capital loss. In certain embodiments, the proceeds received from investors exceed the par value of the instruments. In such cases, the difference between the proceeds received and the par value to be placed in the collateral account support payments to reconcile financial debits and/or credits computed with respect to contingent factors and/or measures impacting the contingent factors, as discussed above.

A sponsor and/or other parties to the issuance can subsequently determine that additional factor-contingent financial instruments be issued for the specified risk class(es) and/or the specified risk class(es) and contingent factor(s). This reflects changing conditions of the sponsor, changing conditions in the market, a need for additional insurance coverage, the availability of additional funds for sponsorship, and/or the potential for increasing implementation of risk-reducing Measures with an additional issuance, for example. The availability of additional funds for sponsorship and/or the potential for additional implementation of risk-reducing Measures is particularly relevant in cases where one or more of the sponsors is a risk interested party and/or a source of funds intended to support risk reductions, and/or in cases where the program is a component of a program to manage the distribution of funds intended to advance risk reductions. This is represented by the “Yes” path from the Decision Node identified in FIG. 9 as “More instruments for risk class and contingent risk factors?”. In this case, the risks, risk profiles, expected loss(es), and/or differentials associated with the contingent factors and potential Measures are re-evaluated for the additional financial instruments, and the additional instruments or collections of instruments are issued. Additional instruments can be issued at regular intervals, periodically, or at any time during the term, according to the terms and conditions of the financial instruments.

During the term of the instruments, the issuer can collect premiums from sponsor(s) and interest from the collateral account. The issuer can also collect premiums, risk-contributing premium differentials, and/or financial transfers to reconcile debits from risk-interested parties and/or parties potentially responsible for risk-contributing measures, as discussed above in relation to FIGS. 6, 7, and 8. During the term of the instruments, the issuer can distribute coupon payments to investors. The issuer can also execute financial transfers reflecting credits, risk-reducing premium differentials, and/or otherwise make payments to parties responsible for risk-reducing measures. Such payments can be made directly to potentially responsible parties and/or to an intermediary responsible for managing such funds and/or payments.

Upon reaching the redemption or maturity date for the risk instruments, represented with the “Yes” path from the Node labeled “Redemption date?” a determination may be made regarding the occurrence of a Trigger Event during the risk period. This is represented by the Decision Node labeled “Trigger event during the risk period?” If it is determined that a Trigger Event occurred during the risk period, represented with the “Yes” path from the Decision Node, then the issuer distributes a portion or all of the value of the collateral account to the sponsor(s). Any remaining portion of the principal can be distributed to the investors. If it is determined that a Trigger Event did not occur during the risk period of the instruments, then the value of the collateral account representing the full par value of the instruments and accrued interest is returned to the investors. This description does not reflect fees, commissions, compensation and/or other types of liabilities that can be reflected in the terms and conditions of the instruments and may impact up on the values of the payments discussed here.

It would be understood by those practiced in the arts of structuring and issuing financial instruments that the methods illustrated in FIG. 9, as well as the processes, systems, and apparatuses used to implement the methods illustrated in FIG. 9, may be implemented in a variety of ways. The structure of the illustration and description provided here is chosen for clarity of disclosure and represents one embodiment for implementing the techniques described herein. The methods described herein can be integrated, aggregated, and/or disaggregated in a variety of ways to accomplish a similar purpose.

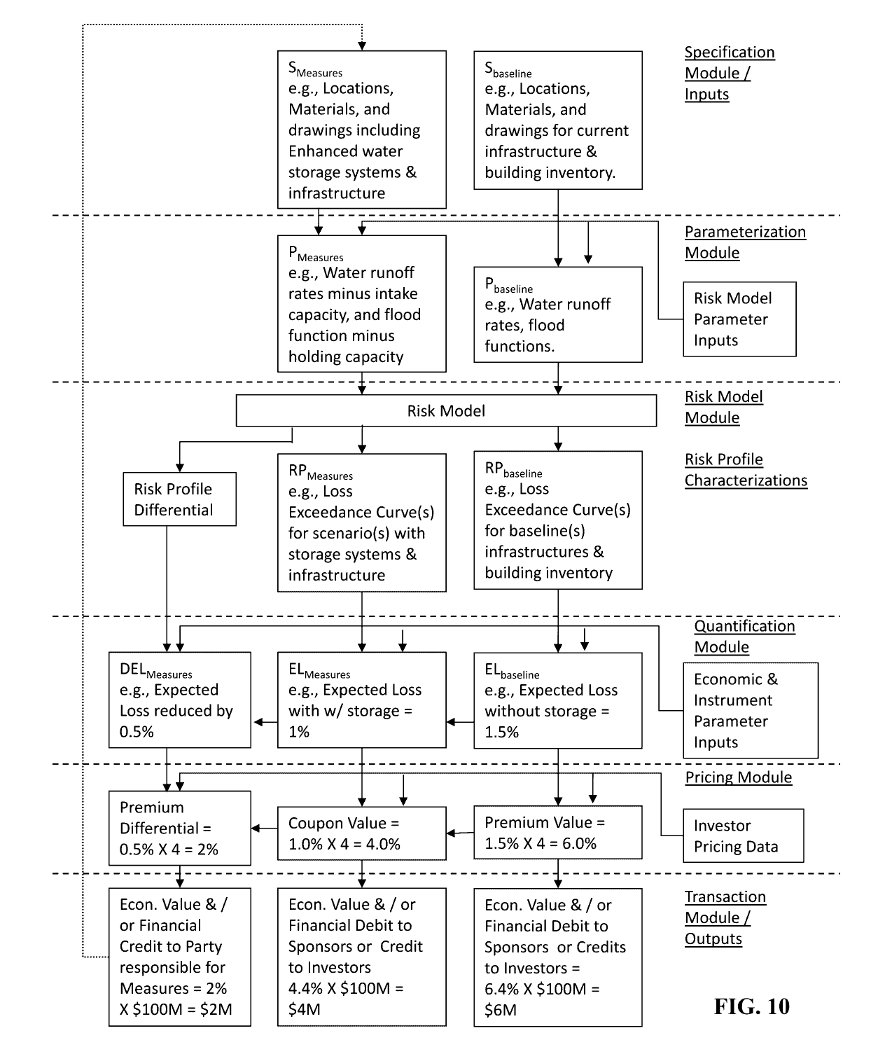

FIG. 10 illustrates the components of a system that may be used to implement the processes applied in various embodiments discussed herein. The system comprises a Specification Module, Parameterization Module, Risk Model Module, Quantification Module, Pricing Module, and a Transaction Module. These modules may be configured to implement the process flows illustrated in FIG. 8 and FIG. 9. The terms and symbols included in FIG. 10 are generally consistent with the terms and symbols used in the discussions of FIG. 8 and FIG. 9 to facilitate its interpretation in the context of those discussions.

FIG. 10 represents a single example of the system and system components. Some embodiments may exclude certain modules that are illustrated in FIG. 10. Processes may be aggregated within fewer modules, or disaggregate processes into more modules to achieve the intended functions.

FIG. 10 includes an illustration of how the system could be applied to an example Measure designed to reduce storm water runoff using a series of enhanced storm water storage facilities and infrastructure. Accordingly, the Specification Module is applied to specify parameters for to scenarios, S_{Baseline} and S_{Measures}. The Parameterization Module is applied to specify parameter sets for the two scenarios to be input to the Risk Model Module, P_{Baseline} and P_{Measures}. The Risk Model Module is applied to define risk profiles for the two scenarios, RP_{Baseline} and RP_{Measures}, Measures, as well as differentials between the risk profiles. The Quantification Module is used to define economic and/or financial implications and values for the two scenarios and differentials between the scenarios. As an example, financial values are indicated in FIG. 10 as the Expected Loss on a financial instrument for the two scenarios, EL_{Baseline} and EL_{Measures}, and a change in the Expected Loss resulting from the Measure, ΔEL. Other economic and/or financial values could also be quantified, consistent with the discussion above. In the example illustrated, ELBaseline is indicated to be a 1.5% expected loss, ELMeasures is indicated to be 1% expected loss, and the resulting change in the expected loss is indicated to be 0.5%. These values are input into the Pricing Module, which applies a pricing function to determine Premiums for the financial instrument under each scenario and a Premium Differential. In the illustrated example, a simplified pricing multiple of four (4) is applied to the expected loss values to define the Premium in the baseline scenario as 6% (1.5%×4=6%). The Premium in the scenario with Measures is defined as 4% (1%×4=4%), and the Premium Differential is defined as 2% (0.5%×4=2%, or equivalently 6%−4%=2%). These premium values and the Premium Differential are applied to a financial instrument with a notional value of $100 M to define Financial Credits and Deficits among various parties to the contemplated instrument.

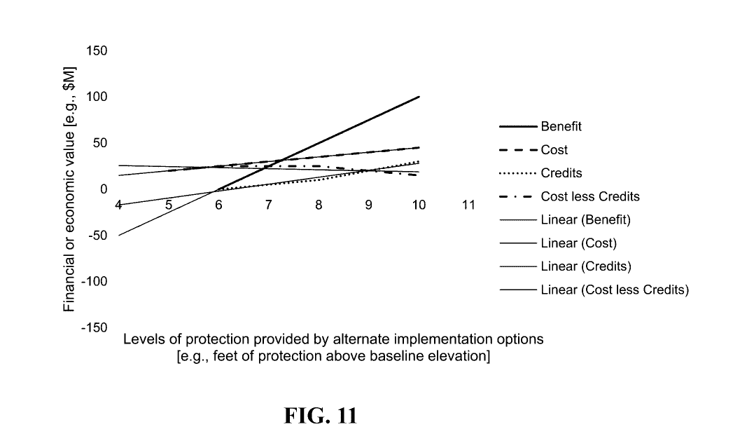

FIG. 11 illustrates an example graphic characterizing the benefits, costs, financial credits, and costs less financial credits for multiple implementation options of a risk-reducing measure. This relates directly to the discussions above regarding FIG. 8 and FIG. 9, among others. The horizontal axis indicates the levels of protection provided by the multiple implementation options. For the purposes of illustrating an example, the level of protection is defined as feet of coastal protection above a baseline elevation. The vertical axis indicates the economic or financial values that characterize benefits, costs, financial credits, and costs less financial credits for each of the implementation options. For the purposes of illustrating an example, the economic or financial value is defined in millions of dollars. Data points for each implementation option are connected to form curves to simplify the illustration.

As illustrated in FIG. 11, costs are indicated for implementation options that provide levels of protection ranging from four (4) feet above the baseline elevation up to ten (10) feet above the baseline elevation; however, the Measure doesn't provide any benefits until a level of protection equivalent to six (6) feet above the baseline elevation is achieved. The intersection between the cost and benefit curves may indicate that the implementation options that provide levels of protection below ˜7.24 feet above the baseline are not cost effective (e.g., costs are greater than benefits). Comparison of the cost and benefit curves further indicate that, while costs increase for increasing levels of protection, both benefits and net benefits (benefits minus costs) also increase with increasing levels of protection. This may be interpreted as indicating that, all else being equal, higher levels of protection are preferred, and that the level of protection achieved will be limited by the budget constraint on total costs.

FIG. 11 also includes a curve for financial credits that may be generated through one or more financial articles, labeled “Credits”, and a curve for the cost to the project sponsor including the benefits of these financial credits, labeled “Cost less Credits”. The Credits curve indicates that the financial articles may provide credits that increase with the level of protection. The Cost less Credits curve indicates that the net cost to the project sponsor, including the financial credits provided by the financial articles, is level for implementation options that achieve levels of protection between six (6) and eight (8) feet above the baseline elevation and that the net cost decreases for implementation options that achieve levels of protection greater than eight (8) feet. As a result, the sponsor's budget constraint should not be a limitation on the level of protection achieved and the implementation option providing the maximum level protection should be implemented.

FIG. 11 illustrates an analysis of economic and/or financial values associated with multiple possible implementation options for a Measure in terms of the level of protection, as defined by the height above a baseline elevation up to which protection is provided. As discussed in the context of FIG. 8 above, related characterizations of economic and/or financial values could be applied to implementation options differentiated in various other ways, including their designs, engineering, construction, or factors and features of implementation. As a result, the systems, methods, and techniques described here can be applied to provide physical protection Measures, to determine which (if any) measures will be implemented, and to define various physical aspects of those Measures, including their designs, engineering, construction, and other aspects of implementation.

The above-described techniques can be implemented in digital and/or analog electronic circuitry, or in computer hardware or firmware, or in combinations of them with software. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special-purpose microprocessors. Generally, a processor receives instructions and data from a read-only memory or a random access memory or both. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein.

What is claimed is:

1. A computerized method for securitizing catastrophic risk, the method comprising:
receiving, at a server computing device, financial instrument data including a premium amount paid by sponsors of the financial instrument to an issuer of the financial instrument and a coupon amount paid by the issuer to an investor in the financial instrument, wherein the financial instrument reflects a financial risk that corresponds to one or more physical risks;
determining, by the server computing device, a first expected loss associated with the financial risk reflected in the financial instrument;
determining, by the server computing device, a second expected loss associated with the financial risk reflected in the financial instrument, wherein the financial risk is adjusted to compensate for risk-reducing measures and/or risk-contributing measures;
determining, by the server computing device, a differential between the first expected loss and the second expected loss;
calculating, by the server computing device, a credit to one or more parties responsible for the risk-reducing measures based upon the differential;
calculating, by the server computing device, a debit to one or more parties responsible for the risk-contributing measures based upon the differential; and
adjusting, by the server computing device, the premium amount and/or the coupon amount based upon the credit and/or the debit.

2. The method of claim 1, wherein the one or more physical risks correspond to a potential for catastrophic damage at a physical location.

3. The method of claim 1, wherein the risk-reducing measures include direct measures and indirect measures that mitigate and/or eliminate the potential for catastrophic damage at the physical location.

4. The method of claim 1, wherein the risk-reducing measures include direct measures and indirect measures that enhance and/or fail to mitigate the potential for catastrophic damage at the physical location.

5. A system for securitizing catastrophic risk, the system comprising a server computing device configured to:
receive financial instrument data including a premium amount paid by sponsors of the financial instrument to an issuer of the financial instrument and a coupon amount paid by the issuer to an investor in the financial instrument, wherein the financial instrument reflects a financial risk that corresponds to one or more physical risks;
determine a first expected loss associated with the financial risk reflected in the financial instrument;
determine a second expected loss associated with the financial risk reflected in the financial instrument, wherein the financial risk is adjusted to compensate for risk-reducing measures and/or risk-contributing measures;
determine a differential between the first expected loss and the second expected loss;
calculate a credit to one or more parties responsible for the risk-reducing measures based upon the differential;
calculate a debit to one or more parties responsible for the risk-contributing measures based upon the differential; and
adjust the premium amount and/or the coupon amount based upon the credit and/or the debit.

6. The system of claim 5, wherein the one or more physical risks correspond to a potential for catastrophic damage at a physical location.

7. The system of claim 5, wherein the risk-reducing measures include direct measures and indirect measures that mitigate and/or eliminate the potential for catastrophic damage at the physical location.

8. The system of claim 5, wherein the risk-reducing measures include direct measures and indirect measures that enhance and/or fail to mitigate the potential for catastrophic damage at the physical location.

9. A computer program product, tangibly embodied in a non-transitory computer readable storage medium, for securitizing catastrophic risk, the computer program product including instructions operable to cause a computing device to:
receive financial instrument data including a premium amount paid by sponsors of the financial instrument to an issuer of the financial instrument and a coupon amount paid by the issuer to an investor in the financial instrument, wherein the financial instrument reflects a financial risk that corresponds to one or more physical risks;
determine a first expected loss associated with the financial risk reflected in the financial instrument;
determine a second expected loss associated with the financial risk reflected in the financial instrument, wherein the financial risk is adjusted to compensate for risk-reducing measures and/or risk-contributing measures;
determine a differential between the first expected loss and the second expected loss;
calculate a credit to one or more parties responsible for the risk-reducing measures based upon the differential;
calculate a debit to one or more parties responsible for the risk-contributing measures based upon the differential; and
adjust the premium amount and/or the coupon amount based upon the credit and/or the debit.

10. A method for implementing physical risk reduction measures for catastrophic risk, the method comprising:
receiving, by a server computing device, information for a plurality of physical infrastructure implementation options relating to risk reduction measures, wherein each physical infrastructure implementation option provides a different level of risk reduction;
receiving, by the server computing device, technical information relating to design and construction of each physical infrastructure implementation option;
receiving, by the server computing device, financial information relating to each physical infrastructure implementation option;
determining, by the server computing device, an expected loss value for each physical infrastructure implementation option;
determining, by the server computing device, a benefit for each physical infrastructure implementation option based upon differences in the expected loss values for the physical infrastructure implementation options;
generating, by the server computing device, a matrix of values that characterize total, net, and marginal benefits associated with each physical infrastructure implementation option;
identifying, by the server computing device, an optimal physical infrastructure implementation option based upon the matrix of values; and
generating, by the server computing device, an engineering plan to design and construct the optimal physical infrastructure implementation option at a physical location.

11. The method of claim 10, further comprising
receiving, at the server computing device, financial instrument data including a premium amount paid by sponsors of the financial instrument to an issuer of the financial instrument and a coupon amount paid by the issuer to an investor in the financial instrument, wherein the financial instrument reflects a financial risk that corresponds to one or more physical risks associated with the plurality of physical infrastructure implementation options;
determining, by the server computing device, a first expected loss associated with the financial risk reflected in the financial instrument;
determining, by the server computing device, a second expected loss associated with the financial risk reflected in the financial instrument, wherein the financial risk is adjusted to compensate for risk-reducing measures and/or risk-contributing measures;
determining, by the server computing device, a differential between the first expected loss and the second expected loss;
calculating, by the server computing device, a credit to one or more parties responsible for the risk-reducing measures based upon the differential;
calculating, by the server computing device, a debit to one or more parties responsible for the risk-contributing measures based upon the differential;
adjusting, by the server computing device, the premium amount and/or the coupon amount based upon the credit and/or the debit; and
adjusting, by the server computing device, the matrix of values that characterize total, net, and marginal benefits associated with each physical infrastructure implementation option based upon the adjusted premium amount and/or the adjusted coupon amount.

12. The method of claim 10, wherein the plurality of physical infrastructure implementation options correspond to design and construction of physical infrastructure changes that reduce a risk of catastrophic damage to a physical location.

13. The method of claim 12, wherein the plurality of physical infrastructure implementation options includes an option to not implement any physical infrastructure changes.

14. The method of claim 10, wherein the risk reduction measures include direct risk reduction measures and indirect risk reduction measures.

15. The method of claim 14, wherein the direct risk reduction measures include construction of physical infrastructure to insulate a physical location from a risk of catastrophic damage.

16. The method of claim 14, wherein the indirect risk reduction measures include revising building codes and property insurance programs to affect quality of physical infrastructure design and construction in a physical location that is susceptible to a risk of catastrophic damage.

17. A system for implementing physical risk reduction measures for catastrophic risk, the system comprising a server computing device configured to:
receive information for a plurality of physical infrastructure implementation options relating to risk reduction measures, wherein each physical infrastructure implementation option provides a different level of risk reduction;
receive technical information relating to design and construction of each physical infrastructure implementation option;
receive financial information relating to each physical infrastructure implementation option;
determine an expected loss value for each physical infrastructure implementation option;
determine a benefit for each physical infrastructure implementation option based upon differences in the expected loss values for the physical infrastructure implementation options;
generate a matrix of values that characterize total, net, and marginal benefits associated with each physical infrastructure implementation option;
identify an optimal physical infrastructure implementation option based upon the matrix of values; and
generate an engineering plan to design and construct the optimal physical infrastructure implementation option at a physical location.

18. The system of claim 17, wherein the server computing device is further configured to
receive financial instrument data including a premium amount paid by sponsors of the financial instrument to an issuer of the financial instrument and a coupon amount paid by the issuer to an investor in the financial instrument, wherein the financial instrument reflects a financial risk that corresponds to one or more physical risks associated with the plurality of physical infrastructure implementation options;
determine a first expected loss associated with the financial risk reflected in the financial instrument;
determine a second expected loss associated with the financial risk reflected in the financial instrument, wherein the financial risk is adjusted to compensate for risk-reducing measures and/or risk-contributing measures;
determine a differential between the first expected loss and the second expected loss;
determine a credit to one or more parties responsible for the risk-reducing measures based upon the differential;
determine a debit to one or more parties responsible for the risk-contributing measures based upon the differential;
adjust the premium amount and/or the coupon amount based upon the credit and/or the debit; and
adjust the matrix of values that characterize total, net, and marginal benefits associated with each physical infrastructure implementation option based upon the adjusted premium amount and/or the adjusted coupon amount.

19. The system of claim 17, wherein the plurality of physical infrastructure implementation options correspond to design and construction of physical infrastructure changes that reduce a risk of catastrophic damage to a physical location.

20. The system of claim 19, wherein the plurality of physical infrastructure implementation options includes an option to not implement any physical infrastructure changes.

21. The system of claim 17, wherein the risk reduction measures include direct risk reduction measures and indirect risk reduction measures.

22. The system of claim 21, wherein the direct risk reduction measures include construction of physical infrastructure to insulate a physical location from a risk of catastrophic damage.

23. The system of claim 21, wherein the indirect risk reduction measures include revising building codes and property insurance programs to affect quality of physical infrastructure design and construction in a physical location that is susceptible to a risk of catastrophic damage.

24. A computer program product, tangibly embodied in a non-transitory computer readable storage device, for implementing physical risk reduction measures for catastrophic risk, the computer program product including instructions operable to cause a server computing device to:
receive information for a plurality of physical infrastructure implementation options relating to risk reduction measures, wherein each physical infrastructure implementation option provides a different level of risk reduction;
receive technical information relating to design and construction of each physical infrastructure implementation option;
receive financial information relating to each physical infrastructure implementation option;
determine an expected loss value for each physical infrastructure implementation option;
determine a benefit for each physical infrastructure implementation option based upon differences in the expected loss values for the physical infrastructure implementation options;
generate a matrix of values that characterize total, net, and marginal benefits associated with each physical infrastructure implementation option;
identify an optimal physical infrastructure implementation option based upon the matrix of values; and
generate an engineering plan to design and construct the optimal physical infrastructure implementation option at a physical location.
